(19) United States
(12) Patent Application Publication
(10) Pub. No.: US 2023/0025067 A1
(43) Pub. Date: Jan. 26, 2023

(54) SOLID LOW FOAMING IN DISSOLUTION AND LOW PH ALL-PURPOSE CLEANER AND DISINFECTANT COMPOSITIONS

(71) Applicant: Reckitt Benckiser LLC, Parsippany, NJ (US)

(72) Inventors: Odafe EJETAVBO, Montvale, NJ (US); Daniel KLARNET, Montvale, NJ (US); Carrie Ann ROMANOV, Montvale, NJ (US); Junho JOO, Montvale, NJ (US); Roger ZAMBRANO, Eindhoven (NL); Jayson WOODBINE, Montvale, NJ (US); Joshua TAMUZZA, Montvale, NJ (US); Gabriel Hohenstein, Eindhoven (NL); Sander Thijssen, Eindhoven (NL); Manuel Zeller, Eindhoven (NL)

(21) Appl. No.: 17/871,331

(22) Filed: Jul. 22, 2022

Related U.S. Application Data
(63) Continuation-in-part of application No. PCT/EP2022/052328, filed on Feb. 1, 2022.

(30) Foreign Application Priority Data
Mar. 5, 2021 (GB) 2103108.3

(51) Int. Cl. A01N 25/34; A01N 25/04; B05B 11/00; A01N 37/04; A01N 37/10; A01N 41/02

(52) U.S. Cl. CPC A01N 25/34; A01N 25/04; B05B 11/3057; B05B 11/0056; A01N 37/04; A01N 37/10; A01N 41/02

(57) ABSTRACT

Solid low foaming and low pH all-purpose cleaning and disinfectant compositions are disclosed. The solid disinfectant compositions comprise approximately 50% w/w to approximately 75% w/w of citric acid encapsulated by a binder and approximately 1% to approximately 5.5% w/w of sodium benzoate. The solid cleaning and disinfectant compositions comprise approximately 50% w/w to approximately 75% w/w of citric acid encapsulated by a binder; approximately 1% to approximately 5.5% w/w of sodium benzoate; and approximately 10% w/w to approximately 15% w/w of sodium lauryl sulfate. The solid compositions are dissolved in water to produce a disinfectant solution comprising approximately 1.2% w/v to approximately 2% w/v citric acid and approximately 0.083% w/v to approximately 0.15% w/v sodium benzoate. A 10 minute contact time with the disinfectant solution provides a 5 log₁₀ reduction in Staphylococcus aureus on a surface.

### CROSS-REFERENCE TO RELATED APPLICATIONS

This application is a continuation in part of PCT application no PCT/EP2022/052328 filed 1 Feb. 2022, claiming priority to GB application no. 2103108.3, filed 5 Mar. 2021, which claims priority to U.S. provisional application No. 63/144,220, filed 1 Feb. 2021, the contents of each being incorporated herein by reference in its entirety.

### BACKGROUND

Cleaning tablets are known in the art. See, e.g., U.S. Pat. No. 3,639,169 to Broeg et al.; U.S. Pat. No. 5,741,520 to Desenna; PCT Pub Nos WO99/65468, WO00/09094, WO01/74988, and WO02/056728 to Chemlink Lab LLC; PCT Pub No WO2002/086048 to Reckitt Benckiser (UK) Limited; U.S. Pat. No. 6,713,441 to DeSenna et al.; PCT Pub No WO2007/147047 to Premier Dental Products Company; US Pat App Pub No 2013/338053 to Casco; PCT Pub No WO2014/152734 to Hercules Inc.; and PCT Pub Nos WO20/172420, WO20/172423, and WO20/214916 to One Home Brands Inc.

Commercial cleaning tablets are also available. See, e.g., the Filo bathroom cleaner (available online at the web address: https://filo.earth/products/bathroom-cleaner).

Citric acid is a common ingredient in these formulations, frequently serving as a pH adjuster/acidifier or an effervescing co-reactant.

Challenges have been encountered related to manufacturing and use of these tablets, particularly due to the hygroscopic nature of citric acid.

Concerns have also been raised that the combination of citric acid and sodium benzoate produces benzene at low pH. See, e.g., Johnson, Life One and Sodium Benzoate, Vol. 29, Issue 1, Page 52, 28 May 2012 (available online at the web address: https://hippocratesinst.org/learning-centre/blog-archive/life-one-and-sodium-benzonate/).

Quaternary ammonium compounds are known disinfectants exhibiting broad spectrum antimicrobial properties against bacteria, fungi, and viruses. However, concerns about resistant strains of bacteria have been investigated as early as the 1960s. See, e.g., Malizia et al., Benzalkonium chloride as a source of infection. N. Engl J Med 263:800-802 1960 and Adair et al., Resistance of Pseudomonas to quaternary ammonium compounds. I. Growth in benzalkonium chloride solution. Appl Microbiol 18:299-302. 1969. Quaternary ammonium compounds are also known skin irritants with occasional reports as allergens (skin sensitizers).

A need remains for cleaning and disinfecting compositions that overcome the deficiencies noted above.

### BRIEF SUMMARY

Acidic disinfectant compositions are disclosed. The acidic disinfect compositions comprise approximately 50% w/w to approximately 75% w/w of citric acid encapsulated by a binder and approximately 1% w/w to approximately 5.5% w/w of sodium benzoate. The disclosed disinfectant compositions may include one or more of the following aspects:
the acidic disinfectant composition being a solid;
the acidic disinfectant composition being a tablet;
the acidic disinfectant composition being a powder;
the acidic disinfectant composition comprising approximately 51% w/w to approximately 60% w/w of the encapsulated citric acid;
the acidic disinfectant composition comprising approximately 52.3% w/w to approximately 57.8% w/w of the encapsulated citric acid;
the encapsulated citric acid having an average particle size of 5% maximum>0.63 mm and 5% maximum<0.100 mm;
the acidic disinfectant composition comprising approximately 3.6% w/w to approximately 4.4% w/w of sodium benzoate;
the sodium benzoate being a solid;
the acidic disinfectant composition being a cleaning and disinfectant composition;
the cleaning and disinfectant composition being a solid;
the cleaning and disinfectant composition being a tablet;
the cleaning and disinfectant composition being a powder;
the cleaning and disinfectant composition further comprising approximately 10% w/w to approximately 25% w/w of powdered sodium lauryl sulfate;
the cleaning and disinfectant composition further comprising approximately 10% w/w to approximately 25% w/w of granular sodium lauryl sulfate;
the cleaning and disinfectant composition further comprising approximately 12.5% w/w to approximately 20% w/w of powdered sodium lauryl sulfate;
the cleaning and disinfectant composition further comprising approximately 12.5% w/w to approximately 20% w/w of granular sodium lauryl sulfate;
the cleaning and disinfectant composition further comprising approximately 14.7% w/w to approximately 18% w/w of powdered sodium lauryl sulfate;
the cleaning and disinfectant composition further comprising approximately 14.7% w/w to approximately 18% w/w of granular sodium lauryl sulfate;
the sodium lauryl sulfate having a bulk density ranging from approximately 0.5 g/mL to approximately 0.7 g/mL;
the acidic disinfectant composition further comprising an effervescent;
the effervescent being an alkali carbonate and/or an alkali bicarbonate;
the effervescent being an alkali carbonate;
the effervescent being an alkali bicarbonate;
the effervescent being sodium carbonate;
the effervescent being potassium carbonate;
the effervescent being sodium bicarbonate;
the acidic disinfectant composition further comprising between 6.8% w/w to 8.3% w/w sodium carbonate;
the sodium carbonate being a solid;
the sodium carbonate solid having an 85% minimum particle size of 150 microns or greater and a 50% maximum particle size of 420 microns;
the acidic disinfectant composition further comprising between 5% w/w to 7% w/w sodium bicarbonate;
the acidic disinfectant composition further comprising a chelant;
the chelant being methylglycine diacetic acid trisodium salt (MGDA);
the chelant being a solid;
the acidic disinfectant composition further comprising between approximately 5.6% w/w to approximately 7.2% w/w of a chelant;
the acidic disinfectant composition further comprising between approximately 5.6% w/w to approximately 7.2% w/w of MGDA;
the acidic disinfectant composition further comprising one or more optional constituents, selected from the group consisting of dye, fragrance, fillers, binders, and combinations thereof;
the fragrance being a powdered or spray dried fragrance;
the acidic disinfectant composition not comprising any added binding agent, such as polyethylene glycol;
the acidic disinfectant composition further comprising a binding agent, such as an alkoxylated alcohol or polyethylene glycol;
the acidic disinfectant composition further comprising a liquid alkoxylated alcohol;
the acidic disinfectant composition further comprising undecyl alcohol ethoxylate with 3-10 degrees of ethoxylation;
the acidic disinfectant composition further comprising undecyl alcohol ethoxylate with 4-9 degrees of ethoxylation;
the acidic disinfectant composition further comprising undecyl alcohol ethoxylate with 5-8 degrees of ethoxylation;
the acidic disinfectant composition further comprising a water-soluble polymer having residual activity, such as a polyethyloxazoline;
the acidic disinfectant composition further comprising a biofilm sealant, such as a polyethyloxazoline;
the polyethyloxazoline being 2-ethyl-2-oxazoline;
the acidic disinfectant composition not being encapsulated in any water-soluble or removable film;
the acidic disinfectant composition being encapsulated in a water-soluble or removable film;
the combined liquid content of all of the ingredients of the acidic disinfectant composition being less than 10% w/w;
the combined liquid content of all of the ingredients of the acidic disinfectant composition being less than 7.5% w/w;
the combined liquid content of all of the ingredients of the acidic disinfectant composition being less than 5% w/w;
the combined liquid content of all of the ingredients of the acidic disinfectant composition being less than 3% w/w;
the solid ingredients added to the acidic disinfectant composition having different particle sizes;
the acidic disinfectant composition being substantially free of additional biocides, such as peroxides, quaternary ammonium compounds, phenolics, bisguanides, or parachlorometaxylenol (PCMX); and/or
the acidic disinfectant composition including no additional biocides, such as peroxides, quaternary ammonium compounds, phenolics, bisguanides, or parachlorometaxylenol (PCMX).

In one embodiment, the disclosed acidic disinfectant composition comprises, consists essentially of, or consists of 52.3 to 57.8% w/w of citric acid encapsulated by maltodextrin having an average particle size<0.63 mm; 2% to 5% w/w of sodium benzoate; 14.7 to 18% w/w of sodium lauryl sulfate having a bulk density ranging from 0.5 g/mL to 0.7 g/mL; 6.8% to 8.3% w/w of sodium carbonate; 5.8% to 7% w/w of chelating agent; and one or more optional constituents, such as dye, fragrance, fillers, binders, polymers, or mixtures thereof, preferably a mixture of dye and fragrance.

Alternatively, the disclosed acidic disinfectant compositions comprises, consists essentially of, or consists of between 63 to 66% w/w of citric acid encapsulated by maltodextrin having an average particle size<0.63 mm; 2% to 5% w/w of sodium benzoate; 12 to 15% w/w sodium lauryl sulfate having a bulk density ranging from 0.5 g/mL to 0.7 g/mL; 5% to 7% w/w of sodium bicarbonate; 4.8% to 7.2% w/w of chelating agent; 0.03% to 1% of a liquid nonionic surfactant; and one or more optional constituents, such as dye, fragrance, fillers, binders, polymers, or mixtures thereof, preferably a mixture of dye and fragrance.

Also disclosed are acidic disinfectant solutions. The acidic disinfectant solution is obtained by dissolving in water the acidic disinfectant compositions disclosed above. The resulting acidic disinfectant solution comprises approximately 1.2% w/v to approximately 2% w/v citric acid and approximately 0.05% w/v to approximately 0.15% w/v sodium benzoate. The disclosed acidic disinfectant solutions may include one or more of the following aspects:
the acidic disinfectant solution comprising approximately 1.3% w/v to approximately 1.6% w/v citric acid;
the acidic disinfectant solution comprising 2% w/v to 2.2% w/v citric acid;
the acidic disinfectant solution comprising approximately 0.083% w/v and approximately 0.14% w/v sodium benzoate;
the acidic disinfectant solution including little to no alkali carbonate and/or alkali bicarbonate;
the acidic disinfectant solution having a pH ranging from approximately 2.5 to approximately 5; and/or
the acidic disinfectant solution having a pH ranging from approximately 2.8 to approximately 4;
the acidic disinfectant solution further comprising an anionic surfactant to produce a cleaning and disinfectant solution;
the anionic surfactant being sodium lauryl sulfate;
the water being heated to a temperature ranging from approximately 25° C. to approximately 60° C.;
the water being heated to a temperature ranging from approximately 30° C. to approximately 50° C.;
the acidic disinfectant compositions dissolving in the water in approximately 1 to 20 minutes at 40-50 C;
the acidic disinfectant compositions dissolving in the water in approximately 1 to 15 minutes at 40-50° C.
the acidic disinfectant compositions dissolving in the water in approximately 1 to 13 minutes at 40-50° C.

Basic disinfectant compositions are also disclosed. The basic disinfectant composition comprises, consists essentially of, or consists of between 10 to 16% w/w of citric acid encapsulated by maltodextrin; 45 to 60% w/w sodium or potassium carbonate; 4 to 5.2% benzalkonium chloride; 7-9% liquid nonionic surfactant; 5.6% w/w to approximately 7.2% w/w of chelating agent; and one or more optional constituents, such as dye, fragrance, fillers, binders, polymers, or mixtures thereof, preferably a mixture of dye and fragrance. The disclosed basic disinfectant compositions may include one or more of the following aspects:
the basic disinfectant composition being a solid;
the basic disinfectant composition being a tablet;
the basic disinfectant composition being a powder;
the encapsulated citric acid having an average particle size of 5% maximum>0.63 mm and 5% maximum<0.100 mm;
the benzalkonium chloride being a mixture of C12-14 alkyl dimethyl ethylbenzyl ammonium chloride and C12-18 alkyl dimethyl benzyl ammonium chloride in an inert matrix;
the basic disinfectant composition being a cleaning and disinfectant composition;
the cleaning and disinfectant composition being a solid;
the cleaning and disinfectant composition being a tablet;
the cleaning and disinfectant composition being a powder;
the disinfectant composition further being effervescent;
the sodium or potassium carbonate being a solid;
the sodium carbonate solid having an 85% minimum particle size of 150 microns or greater and a 50% maximum particle size of 420 microns or smaller;
the potassium carbonate solid having 63% particle size of <45 microns, 22% particle size ranging from 45 microns to 90 microns, 13% particle size ranging from 90 microns to 150 microns, and 2% particle size ranging from 150 microns to 250 microns;
the basic disinfectant composition further comprising one or more optional constituents, selected from the group consisting of dye, fragrance, fillers, binders, and combinations thereof;
the fragrance being a powdered or spray dried fragrance;
the basic disinfectant composition not comprising any added binding agent, such as polyethylene glycol;
the liquid nonionic surfactant being a liquid alkoxylated alcohol;
the liquid nonionic surfactant being undecyl alcohol ethoxylate with 3-10 degrees of ethoxylation;
the liquid nonionic surfactant being undecyl alcohol ethoxylate with 4-9 degrees of ethoxylation;
the liquid nonionic surfactant being undecyl alcohol ethoxylate with 5-8 degrees of ethoxylation;
the liquid nonionic surfactant being a first undecyl alcohol ethoxylate with 5 degrees of ethoxylation and a second undecyl alcohol ethoxylate with 8 degrees of ethoxylation;
the basic disinfectant composition further comprising a water-soluble polymer having residual activity, such as a polyethyloxazoline;
the basic disinfectant composition further comprising a biofilm sealant, such as a polyethyloxazoline;
the polyethyloxazoline being 2-ethyl-2-oxazoline;
the basic disinfectant composition not being encapsulated in any water-soluble or removable film;
the basic disinfectant composition being encapsulated in a water-soluble or removable film;
the combined liquid content of all of the ingredients of the basic disinfectant composition being less than 15% w/w;
the combined liquid content of all of the ingredients of the basic disinfectant composition being less than 13% w/w;
the combined liquid content of all of the ingredients of the basic disinfectant composition being less than 12% w/w; and
the combined liquid content of all of the ingredients of the basic disinfectant composition being less than 11% w/w;
the solid ingredients added to the disinfectant composition having different particle sizes;
the basic disinfectant composition being substantially free of additional biocides, such as peroxides, phenolics, bisguanides, or parachlorometaxylenol (PCMX); and/or
the basic disinfectant composition including no additional biocides, such as peroxides, phenolics, bisguanides, or parachlorometaxylenol (PCMX).

In one embodiment, the disclosed basic disinfectant composition comprises, consists essentially of, or consists of between 11 to 13% w/w of citric acid encapsulated by maltodextrin; 48 to 52% w/w sodium carbonate; 4 to 4.8% solid benzalkonium chloride; 7-8% liquid nonionic surfactant; 5.6% w/w to approximately 7.2% w/w of MGDA; and one or more optional constituents, such as dye, fragrance, fillers, binders, polymers, or mixtures thereof, preferably a mixture of dye and fragrance.

Alternatively, the disclosed basic disinfectant composition comprises, consists essentially of, or consists of between 14 to 16% w/w of citric acid encapsulated by maltodextrin; 53.5 to 55.5% w/w potassium carbonate; 4 to 4.8% solid benzalkonium chloride; 8-9% of a blend of two or more liquid nonionic surfactants; 5.6% w/w to approximately 7.2% w/w of MGDA; and one or more optional constituents, such as dye, fragrance, fillers, binders, polymers, or mixtures thereof, preferably a mixture of dye and fragrance.

Basic disinfectant solutions are also disclosed. The basic disinfectant solution is obtained by dissolving in water the basic disinfectant compositions disclosed above. The resulting basic disinfectant solution comprises approximately 0.1% w/v to approximately 0.3% w/v benzalkonium chloride and approximately 1.5% w/v to approximately 2% w/v sodium or potassium carbonate. The disclosed basic disinfectant solutions may include one or more of the following aspects:
the basic disinfectant solution comprising approximately 0.15% w/v to approximately 0.25% w/v benzalkonium chloride;
the basic disinfectant solution comprising approximately 0.19% w/v to approximately 0.21% w/v benzalkonium chloride;
the basic disinfectant solution comprising approximately 0.16% w/v to approximately 0.18% w/v benzalkonium chloride;
the basic disinfectant solution comprising 0% w/v to less than 0.001% w/v citric acid;
the basic disinfectant solution having a pH ranging from approximately 9.5 to approximately 10.5;
the water being heated to a temperature ranging from approximately 25° C. to approximately 60° C.;
the water being heated to a temperature ranging from approximately 30° C. to approximately 50° C.;
the basic disinfectant compositions dissolving in the water in approximately 1 to 20 minutes at 40-50 C;
the basic disinfectant compositions dissolving in the water in approximately 1 to 15 minutes at 40-50 C;
the basic disinfectant compositions dissolving in the water in approximately 1 to 10 minutes at 40-50 C.

Disinfectant kits are also disclosed. The disinfectant kit comprises a powder or tablet consisting of the acidic or basic disinfectant compositions disclosed above and a bottle having a fill line at a volume sufficient to obtain the acidic or basic disinfectant solutions disclosed above from the acidic or basic disinfectant composition and water. The disclosed disinfectant kits may include one or more of the following embodiments:
the bottle comprising a neck connected to a body via a concave shoulder;
the bottom of the concave shoulder being higher on one side of the bottle than on the other;
the shoulder occupying between approximately 5% to approximately 15% by volume of the bottle;
the bottle having opposing concave shoulders with the bottom of one shoulder higher than the bottom of the opposite shoulder;
the fill line of the bottle being at the bottom of the higher shoulder;
the shoulders occupying between approximately 20% to approximately 30% by vertical linear area of the bottle;
the shoulders occupying between approximately 5% to approximately 15% by volume of the bottle;
the shoulder patterned by (a) horizontally oriented concentric rings that run parallel to the slope between the lower and higher shoulders; (b) vertically oriented lines parallel to the concave shoulder; and (c) indentations formed between the concentric rings and vertically oriented lines;
indentation with pattern showing different shapes at different angles
the bottle comprising 100% post consumer recycled (PCR) resin;
the bottle comprising 100% post consumer recycled polyethylene terephthalate (PET);
the bottle comprising a compostable and recyclable waterproof paper laminate material;
the bottle further comprising a neck that receives a snap-on-trigger;
the bottle further comprising a neck that receives a screw-on trigger;
the bottle further comprising a neck that receives a child-resistant screw-on trigger;
the bottle further comprising a neck that receives a hybrid snap-on/screw-on trigger;
the bottle further comprising a neck that receives a friction-fit trigger;
the base of the bottle having a length longer than any parallel length of the bottle;
the disinfectant kit further including a snap-on spray trigger that delivers approximately 0.75 mL to approximately 3 mL of liquid/stroke;
the disinfectant kit further including a snap-on spray trigger that delivers approximately 1 mL to approximately 2 mL/stroke;
the disinfectant kit further including a snap-on spray trigger that delivers approximately 1.3 mL of liquid/stroke;
the disinfectant kit further including a screw-on spray trigger that delivers approximately 0.75 mL to approximately 3 mL of liquid/stroke;
the disinfectant kit further including a screw-on spray trigger that delivers approximately 1 mL to approximately 2 mL/stroke; and/or
the disinfectant kit further including a screw-on spray trigger that delivers approximately 1.3 mL of liquid/stroke.

Also disclosed are detergent packs comprising a packaging container containing any of the acidic or basic disinfectant compositions disclosed above. The packaging container comprises a three-layer laminate material. The detergent packs include one or more of the following aspects: the disinfectant composition being a powder;
the disinfectant composition being a tablet;
the tablet weighing between approximately 5 g and approximately 15 g;
the tablet weighing between approximately 7.5 g to approximately 12.5 g;
the tablet weighing between approximately 7.5 to approximately 10 g;
the tablet weighing between approximately 10 to approximately 12 g;
the packaging container containing between 1 and 12 tablets;
the packaging container containing between 2 and 9 tablets;
the packaging container containing between 3 and 6 tablets;
the packaging container containing between 3 and 4 tablets;
the three-layer laminate material comprising an aluminum layer located between a polyethylene (PE) layer and a polyethylene terephthalate (PET) layer;
the three-layer laminate material comprising an aluminum layer having a thickness ranging from approximately 6 microns to approximately 10 microns; a PE layer having a thickness ranging from approximately 28 microns to approximately 32 microns, and a PET layer having a thickness ranging from approximately 10 microns to approximately 14 microns;
the three-layer laminate material comprising an aluminum layer having a thickness ranging from approximately 7 microns to approximately 9 microns; a PE layer having a thickness ranging from approximately 29 microns to approximately 31 microns, and a PET layer having a thickness ranging from approximately 11 microns to approximately 13 microns;
the PE layer contacting the tablets;
the packaging container formed by three seams in overlapping portions of the three-layer laminate material, a top seam which spans a width at one end, a bottom seam that spans the width at the opposite end, and a side seam that spans a length between the end seams, forming a tubular package measuring approximately 110 mm to approximately 130 mm long by approximately 20 mm to approximately 30 mm wide,

Also disclosed are methods to improve the disinfecting activity of citric acid by combining 1.2% w/v to 2% w/v citric acid with approximately 0.083% w/v to approximately 0.15% w/v sodium benzoate in a disinfectant solution.

A method of providing a 5 log₁₀ reduction in Staphylococcus aureus on a surface in 2 minutes is also disclosed. The method comprises adding water to a fill line of a bottle. Any one of the acidic or basic disinfectant compositions disclosed above is added a bottle containing water to produce the disinfectant solutions disclosed above. A spray trigger is placed on the bottle and the disinfectant solution sprayed on the surface. After 10 minutes, the surface is wiped to produce a 5 log₁₀ reduction in Staphylococcus aureus on the surface.

The above embodiments are exemplary only. Other embodiments as described herein are within the scope of the disclosed subject matter.

### BRIEF DESCRIPTION OF THE SEVERAL VIEWS OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a picture of some exemplary tablets according to the present invention;

FIG. 2 is a picture of foam flowing out of the neck of a bottle;

FIG. 3 is a flow chart demonstrating the method of using the disclosed kits;

FIG. 4 is a front perspective view of the bottle used in the disinfectant kits disclosed herein;

FIG. 5a is a top view of the tubular pillow pouch that holds the disinfectant compositions disclosed herein;

FIG. 5b is a side view of the tubular pillow pouch that holds the disinfectant compositions disclosed herein;

FIG. 6 is a graph of weight versus time at 40° C. and 75% relative humidity for a jar containing sodium carbonate or sodium percarbonate as explained in Example 13.

### DEFINITIONS

As used herein, the term “a” or “an” means one or more.

As used herein, the term “approximately” or “about” means plus or minus 10 percent of the value stated.

As used herein, the w/w percent of an ingredient is based on the weight of the ingredient in grams in the total weight of the formulation in grams and the w/v percent of an ingredient is based on the weight of the ingredient in grams in the total volume of liquid in mL. When an ingredient does not contain 100% active material, two percentages may be provided: one for the weight of the ingredient and one for the weight of the active.

As used herein, any and all ranges are inclusive of their endpoints. For example, a pH ranging from 2.5 to 3.5 would include formulations having a pH of 2.5, formulations having a pH of 3.5, and formulations having any pH between 2.5 and 3.5.

As used herein, the term “solid” refers to a state of matter characterized by particles arranged such that its shape and volume are relatively stable. A solid state of matter differs from a liquid or gaseous states of matter. A solid state of matter includes powders and tablets.

As used herein, the terms “germ” means microorganisms which causes disease and encompasses both bacteria and viruses; “germicidal” means formulations that inactivate (or kill) germs and microbes.

As used herein, the terms “disinfect,” “disinfecting,” and “disinfection” mean providing equal to or greater than a 3 log₁₀ reduction in 0.1 to 5 minutes of germs on a surface, with the germs including Staphylococcus aureus and Klebsiella pneumoniae.

As used herein, the term “acidic” refers to pH and includes formulations having a pH less than 7, preferably ranging from approximately 2 to approximately 5.

As used herein, the term “basic” refers to pH and includes formulations having a pH greater than 7, preferably ranging from approximately 8 to approximately 12, preferably from approximately 9 to approximately 11.

As used herein, the term “comprising” is inclusive or open-ended and does not exclude any additional elements; the term “consisting of” excludes any additional elements; and the term “consisting essentially of” is in-between, only permitting additional elements that do not materially affect characteristics of the product or process.

As used herein, the phrase “substantially free” means a concentration of less than 0.2 g/L, preferably less than 0.1 g/L, more preferably less than 0.05 g/L, and most preferably 0.001 g/L.

### DETAILED DESCRIPTION

Solid cleaning and/or disinfecting compositions are disclosed. The acidic solid cleaning and/or disinfecting compositions include a synergistic combination of citric acid and sodium benzoate. The basic solid cleaning and/or disinfecting composition include a combination of citric acid, benzalkonium chloride, and nonionic surfactants. When the solid cleaning and/or disinfecting compositions are dissolved in water, the resulting cleaning and/or disinfecting solutions exhibits superior germ kill. The acidic formulation also delivers superior CSPA soapscum and lime scale removal.

Citric acid is a known disinfectant. See, e.g., Dvorak, Disinfection 101, Center for Food Security and Public Health, May 2008. Lemon juice is a frequently used ingredient for green cleaning. Lemon juice contains approximately 5-8% citric acid, amongst other potentially disinfecting ingredients like malic acid, ascorbic acid, and essential oils. However, it also leaves behind a sticky residue.

Citric acid is also hygroscopic, making it difficult to use in large quantities in tablets. See infra Example 2. As a result, coated or encapsulated citric acid products have been developed. See, e.g., U.S. Pat. No. 2,956,926 to Greif. Optimization of the type and amount of coating is necessary to obtain the desired tablet properties.

Applicants have discovered that citric acid encapsulated by a binder provides the reaction and dissolution rates required for the present formulation. Polysaccharide binders, such as maltodextrin, are preferred. Maltodextrin has a melting point of 240° C. Applicants believe that polysaccharides or other binders with similar melting points may work effectively in the present invention. Citric Acid DC sold by JBL containing 96% w/w citric acid in a maltodextrin binder works particularly well. The particle size of the Citric Acid DC powder has a maximum of 5%>0.63 mm and a maximum of 5%<0.100 mm.

For tablet embodiments, the binder encapsulant may provide sufficient binding activity to form a tablet so that a further binder is not required in the solid formulation. Alternatively, the solid formulation may include an additional binder, such as the alcohol ethoxylates sold by BASF under the trade name Lutensol™ AT 25 or the polyethylene glycols sold by BASF under the trade names Pluriol™ E4000 or Pluriol™ E6000. Any additional binder should be selected so as not to impact dissolution rate.

Alternatively, a co-crystal of citric acid may be used. Co-crystals are solid crystalline structures containing two or more solid components held together by non-covalent forces in a defined stoichiometric ratio. As water is liquid at room temperature, hydrates are not considered co-crystals. Similarly, co-crystals do not include two or more materials that crystallize at the same time but in individual and separate crystalline lattices (concurrent crystallization).

A citric acid-nicotinamide co-crystal may be prepared by mixing 250 mg of a 1:2 molar mixture of citric acid and nicotinamide in a stainless steel jar with 100 μL of ethanol using 2 stainless steel grinding balls having a 7 mm diameter. The mixture is ground for approximately 30 minutes using a Retsch MM200 ball mill at a frequency of 30 Hz. See, e.g., Pagire et al., Improving the Stability of Effervescent Products by Co-Crystal Formulation: A Novel Application of Crystal Engineered Citric Acid, Cryst. Growth Des., 2020, 20, 7, 4839-4844. Alternatively, the co-crystal may be formed from citric acid combined with ascorbic acid, malic acid, tartaric acid, isonicotinamide, histidine, urea, saccharine, glycine, tyrosine, vanillin, and/or valine. See, e.g., PCT Pub No WO2016/001681 to University of Bradford.

In another alternative, the solid disinfectant formulation may further comprise a water-soluble polymer or biofilm sealant having residual activity, such as a polyethyloxazoline. Suitable polyethyloxazolines include 2-ethyl-2-oxazoline sold under the tradename Aquazol™ 500 by Polymer Chemistry Innovations, Inc. The polymer concentration may range from approximately 0.05% w/w to approximately 5% w/w. Preferably, the concentration is chosen so as to minimize impact to dissolution of the disinfectant formulation in solution, while still providing a thin coating on the surface to which it is applied.

Applicants have found that solid formulations containing approximately 50% w/w to approximately 75% w/w, preferably approximately 51% w/w to approximately 60% w/w, and more preferably approximately 52.3% w/w to approximately 57.8% weight/weight (w/w) of citric acid encapsulated by a binder provide sufficient reactant for effervescence and germ kill in solution. The resulting solution contains approximately 1.2% w/v to approximately 2% w/v citric acid, preferably from approximately 1.3% w/v to approximately 1.6% w/v. One of ordinary skill in the art will know how to calculate the quantity of solid composition and volume of water needed to produce the desired concentration of citric acid in solution, with or without effervescing agents.

Alternatively, the disclosed disinfectant formulations comprise between approximately 63% to approximately 66% w/w citric acid encapsulated by a binder. The resulting solution contains 2% w/v to 2.2% w/v citric acid.

Applicants have further surprisingly discovered that enhanced germ kill is obtained from a combination of citric acid and sodium benzoate. As discussed above, lemon juice contains 5-8% citric acid, amongst other potentially disinfecting ingredients like malic acid, ascorbic acid, and essential oils. Prior to this project, R&D testing had demonstrated that aqueous solutions containing 2.5% w/v of citric acid did not produce consistent or satisfactory germ kill results. Surprisingly, the inventors have discovered that aqueous solutions containing approximately 1.2% w/v to approximately 2% w/v citric acid and approximately 0.05% w/v to approximately 0.15% w/v sodium benzoate reproducibly provide consistent germ kill results, without the need for any other biocides, such as peroxides, quaternary ammonium compounds, phenolics, biguanides or parachlorometaxylenol (PCMX).

Applicants have found that tablets containing approximately 1% w/w to approximately 5.5% w/w, preferably approximately 2% w/w to approximately 5% w/w approximately, and more preferably approximately 3.6% w/w to approximately 4.4% w/w of sodium benzoate provide the concentration required for enhanced germ kill in solution. Once again, one of ordinary skill in the art will know how to calculate the quantity of solid composition and volume of water needed to produce the desired concentration of sodium benzoate in solution.

Concerns have been raised that the combination of citric acid and sodium benzoate produces benzene at low pH (below 3.8 according to Johnson supra). Sodium benzoate has a pKa of 4.2, meaning that slightly more benzoic acid is in a solution at a pH of 3.8. The anionic cleaning surfactants help to increase the pKa of sodium benzoate. See, e.g., Formulating with Kalaguard™. SB by Emerald Performance Materials. This reduces the amount of benzoic acid in solution and the potential for benzene impurities.

Also disclosed are basic solid cleaning and/or disinfectant compositions containing between approximately 10% w/w and 16% w/w of citric acid encapsulated by a binder. The citric acid provides sufficient reactant for effervescence. In this embodiment, all of the citric acid is consumed in the effervescent reaction. The resulting solution contains 0% w/v to less than 0.001% w/v citric acid.

Both the acidic and basic solid cleaning and/or disinfecting compositions may further include an effervescent agent, such as an alkali carbonate and/or alkali bicarbonate. Exemplary alkali carbonates include sodium carbonate, potassium carbonate, the corresponding hydrate salts thereof, and mixtures thereof. Exemplary alkali bicarbonates include sodium bicarbonate, potassium bicarbonate, the corresponding hydrate salts thereof, and mixtures thereof. The effervescent agent helps speed up dissolution of the solid composition in tap water. As shown in the reaction below, the alkali carbonates react with citric acid to produce carbon dioxide bubbles.

2H₃C₆H₅O₇+3Na₂CO₃→2Na₃C₆H₅O₇+3CO₂+3H₂O

The acidic cleaning and/or disinfecting compositions include an excess of citric acid, resulting in acidic solutions in water. The basic cleaning and/or disinfecting compositions include an excess of carbonate, resulting in basic solutions in water.

In the acidic formulations, the concentration of citric acid should be increased so that an effective concentration of citric acid remains in solution. The solid compositions are formulated so that all of the alkali carbonate and/or alkali bicarbonate is consumed during the effervescence reaction. The solution produced from the reaction of the solid composition with water contains little to no alkali carbonate and/or alkali bicarbonate, as evidenced by the low pH of the resulting solution. The concentration of alkali carbonate or alkali bicarbonate is selected to produce sufficient carbon dioxide to mix the ingredients with water without foam overflowing from the bottle. In the present formulations, Applicants have found approximately 6.5% w/w to approximately 8.3% w/w sodium carbonate grade 100 to provide suitable foaming behavior. Alternatively, approximately 5% w/w to approximately 7% w/w sodium bicarbonate may be used. One of ordinary skill in the art will recognize that different concentrations may be required for alternative carbonates and bicarbonates without departing from the teachings herein.

In the basic formulations, the concentration of carbonate is increased so that an effective amount of carbonate remains in solution. The solid compositions are formulated so that all of the citric acid is consumed during the effervescence reaction. The solution produced from the reaction of the solid composition with water contains little to no citric acid, as evidenced by the high pH of the resulting solution. The concentration of citric acid is selected to produce sufficient carbon dioxide to mix the ingredients with water without foam overflowing from the bottle. In the present formulations, applications have found approximately 10% w/w to approximately 16% w/w citric acid to provide suitable foaming behaviour.

As shown in Example 13 infra, the basic formulations preferably include a carbonate. The carbonate provides stability benefits over the bicarbonate by allowing more moisture to be absorbed in the final product before the autocatalytic reaction begins. The basic formulations contain approximately 45% w/w to approximately 60% w/w carbonate, preferably approximately 50% w/w to approximately 55% w/w. The carbonate may be potassium carbonate, sodium carbonate, potassium carbonate hydrate, sodium carbonate hydrate, or combinations thereof. The carbonate hydrates exhibit better surfactant absorption than the non-hydrate forms of carbonate improving formation of the tablets.

Applicants have discovered that tablet formation improves when the raw materials have differing particle sizes. Applicant believes raw materials having different particle sizes provide a better tablet matrix. Preferably, the sodium carbonate has an 85% minimum particle size of 150 microns or greater and a 50% maximum particle size of 420 microns or less. The potassium carbonate solid has 63% particle size of <45 microns, 22% particle size ranging from 45 microns to 90 microns, 13% particle size ranging from 90 microns to 150 microns, and 2% particle size ranging from 150 microns to 250 microns.

The basic solid cleaning and/or disinfecting composition includes benzalkonium chloride. The concentration of benzalkonium chloride in the basic solid cleaning and/or disinfecting composition ranges from approximately 4% w/w to approximately 5.2% w/w. Preferably the basic solid cleaning and/or disinfecting composition includes a mixture of C12-14 alkyl dimethyl ethylbenzyl quaternary ammonium chloride and C12-18 alkyl dimethyl benzyl quaternary ammonium chloride in an inert matrix. One suitable source of the mixture of C12-14 alkyl dimethyl ethylbenzyl quaternary ammonium chloride and C12-18 alkyl dimethyl benzyl quaternary ammonium chloride in an inert matrix is BTC 2125M P40 in urea having 117 μm average particle size from Stepan.

The acidic solid cleaning and/or disinfecting composition may further include a cleaning surfactant, such as an anionic surfactant. Exemplary anionic surfactants include sodium lauryl sulfate, sodium laureth sulfate, sodium lauryol methyl isethionate, and combinations thereof. The cleaning surfactants improve the cleaning properties of the product. Solid cleaning surfactants are preferable for ease of tablet formulation. Preferably, the solid cleaning and/or disinfecting compositions comprises approximately 14.7% w/w to approximately 18% w/w of sodium lauryl sulfate. The sodium lauryl sulfate having a bulk density ranging from approximately 0.5 g/mL to approximately 0.7 g/mL.

The basic solid cleaning and/or disinfecting composition may further include a cleaning surfactant, such as a nonionic surfactant. The nonionic surfactant also serves as a binding agent due to the low quantity of citric acid included in the basic formulations. The composition comprises between approximately 7% w/w to approximately 9% w/w nonionic surfactant. Exemplary nonionic surfactants include liquid alkoxylated alcohols. Applicants have obtained better cleaning from shorter chain alkoxylated alcohols. Undecyl alcohol ethoxylate is particularly suitable for cleaning polymerized grease. The shorter chain alkoxylated alcohols are also more soluble than their longer chain analogs. The nonionic surfactant may have 3 to 10 degrees of ethoxylation, preferably between 4 to 9 degrees of ethoxylation, and more preferably between approximately 5 to 8 degrees of ethoxylation. Particularly preferred nonionic surfactants include undecyl alclohol ethoxylate with 3 to 10 moles of ethoxylation, preferably between 4 to 9 degrees of ethoxylation, and more preferably between approximately 5 to 8 degrees of ethoxylation. These surfactants are commercially available from Stepan under the Makon™ UD product line, including but not limited to Makon UD-5, Makon UD-6, and Makon UD-8, or mixtures thereof. A blend of undecyl alcohol ethoxylate with 5 moles ethoxylation and undecyl alcohol ethoxylate with 8 moles ethoxylation exhibited superior cleaning results compared to formulations containing a single alcohol ethoxylate.

Both the acidic and basic solid cleaning and/or disinfecting composition may further include a chelant to keep the final solution clear. Suitable chelants include methylglycine diacetic acid trisodium salt (“MGDA” also known as trisodium N-iminodiacetate or trisodium alpha-DL-alanine diacetate), ethylenediaminetetraacetic acid (EDTA), tetrasodium glutamate diacetate (GLDA), tetrakis hydroxmethyl phosphonium sulfate (THPS), diethylenetriaminepentaacetic acid (DTPA), or combinations thereof. In the acidic formulations, the chelant should be effective at a low pH ranging from approximately 2 to approximately 5, preferably from approximately 3 to approximately 4. As shown in the examples that follow, MGDA performed well in both acidic and basic formulations.

The solid cleaning and/or disinfecting compositions may include other excipients commonly used in household cleaning products, such as fragrance, dye, fillers, binders, or combinations thereof. Due to the solid formulation, the fragrance is preferably powdered or spray dried. The powdered or spray dried fragrance preferably contains approximately 10% to approximately 50% by weight of the fragrance oil on a suitable substrate. Exemplary substrates include starches, silica blends, silica and salt, such as sodium chloride or potassium iodide, or combination thereof.

The combined liquid content of all of the ingredients in acidic formulation should not exceed 10% w/w of the final solid formulation, preferably ranging from approximately 0.1% w/w to approximately 7.5% w/w.

The combined liquid content of all of the ingredients in basic formulation should not exceed 15% w/w of the final solid formulation, preferably ranging from approximately 0.1% w/w to approximately 11% w/w.

The solid cleaning and/or disinfecting composition may be in powdered or tablet form. The powder or tablet may be encapsulated in a water-soluble or removable film. Suitable water-soluble films include polymeric films or water-soluble paper. Alternatively, the powder may be provided in a single or multi-use containers, such as a pouch or bucket. A suitably sized scoop may be included with multi-use containers.

The weight of the cleaning and/or disinfecting tablets may range from about 0.5 g to about 500 g, preferably from about 1 g to about 30 g, more preferably from about 5 g to about 10 g. The solid cleaning and/or disinfecting composition is sized to be suitable for its intended purpose. Smaller sized tablets may be provided for single use purposes, ranging in weight from about 0.5 g to about 1 g. Larger size tablets ranging from about 400 g to about 500 g may be provided for commercial purposes, such as hotel or other large-scale cleaning operations. Applicants have found that three (3) 8.3 g tablets are suitably sized for use with standard 750 mL cleaning bottles.

The tablets have an overall hardness that may be measured by acceptable industry standards, such as USP Test Method 1217, or using suitable tablet hardness tester equipment. The load at fracture may be determined in kiloponds (kp). A kilopond is a metric unit of force with 1 kp equivalent to 9.807 Newtons. The hardness of the tablets may range from about 0.2 to about 8 kp, preferably from about 0.7 to about 5.8 kp, more preferably from about 1.5 to 5.5 kp, and most preferably from about 2 to about 5.2 kp.

The tablets are also analyzed for resistance to breaking using tablet friability tests according to industry standards, such as USP Test Method 1216 or other acceptable standards. Using an ERWEKA TAR 220 friability tester at 25 RPM, the friability weight loss measurement of the tablet is less than 5 percent weight loss, preferably less than 4 percent, more preferably less than 3 percent, and most preferably less than 2 percent.

A particularly preferred acidic solid cleaning and disinfecting composition comprises, consists essentially of, or consists of:

a. 14.7 to 18% w/w of sodium lauryl sulfate having a bulk density ranging from 0.5 g/mL to 0.7 g/mL;

b. 52.3 to 57.8% w/w of citric acid encapsulated by maltodextrin having an average particle size<0.63 mm;

c. 6.8% to 8.3% w/w of sodium carbonate;

d. 5.8% to 7% w/w of chelating agent;

e. 3.6% to 4.4% w/w of sodium benzoate; and

f. one or more optional constituents, such as dye, fragrance, fillers, binders, polymers, or mixtures thereof, preferably a mixture of dye and fragrance.

Alternatively, the acidic solid cleaning and disinfecting composition comprises, consists essentially of, or consists of:

a. 12 to 15% w/w of sodium lauryl sulfate having a bulk density ranging from 0.5 g/mL to 0.7 g/mL;

b. 63 to 66% w/w of citric acid encapsulated by maltodextrin having an average particle size<0.63 mm;

c. 5% to 7% w/w of sodium bicarbonate;

d. 4.8% to 7.2% w/w of chelating agent;

e. 2% to 5% w/w of sodium benzoate;

f. 0.1% to 1% liquid nonionic surfactant; and

g. one or more optional constituents, such as dye, fragrance, fillers, binders, polymers, or mixtures thereof, preferably a mixture of dye and fragrance. The bicarbonate produces a faster reaction with less gas production and therefore less foam than produced by the carbonate-containing formulation above.

A particularly preferred basic solid cleaning and disinfecting composition comprises, consists essentially of, or consists of:

a. 4 to 5.2% w/w of benzalkonium chloride;

b. 11 to 13% w/w of citric acid encapsulated by maltodextrin having an average particle size<0.63 mm;

c. 48% to 52% w/w of sodium carbonate;

d. 5.6% to 7.2% w/w of chelating agent;

e. 7% to 8% liquid nonionic surfactant; and

f. one or more optional constituents, such as dye, fragrance, fillers, binders, polymers, or mixtures thereof, preferably a mixture of dye and fragrance.

Alternatively, the basic solid cleaning and disinfecting composition comprises, consists essentially of, or consists of:

a. 4 to 5.2% w/w of benzalkonium chloride;

b. 14 to 16% w/w of citric acid encapsulated by maltodextrin having an average particle size<0.63 mm;

c. 53.5% to 55.5% w/w of potassium carbonate;

d. 5.6% to 7.2% w/w of chelating agent;

e. 8% to 9% of a blend of two or more liquid nonionic surfactants; and

f. one or more optional constituents, such as dye, fragrance, fillers, binders, polymers, or mixtures thereof, preferably a mixture of dye and fragrance.

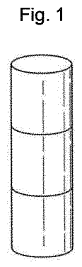

To formulate the disclosed acidic cleaning and/or disinfecting compositions, the ingredients are mixed in a powder mixer, such as a ribbon blender, until uniform. Due to the effervescent nature of the formulation, complete uniformity of the ingredients is not necessary. For tablets, the desired tablet weight is measured from the uniform mixture and added to the dye of a tablet press. The cleaning and/or disinfecting tablet is produced by compression using the tablet press. In R&D testing, the pressure was set at 80 N. During scale up testing, Applicant discovered that use of granulated sodium lauryl sulfate produces tablets exhibiting less friability than those produced by powdered sodium lauryl sulfate. One of ordinary skill in the art will recognize that the specific ingredients and tablet size will dictate the pressure needed to produce the cleaning and disinfecting tablet. A picture of some exemplary tablets is provided in FIG. 1.

The formulation instructions for the basic cleaning and/or disinfecting composition are provided in Example 11, infra.

Neither the acidic nor basic cleaning and/or disinfecting formulations include any added water. Expressly adding water to the formulations may generate an early reaction between the effervescent components. Any water molecules contained in the raw materials do not integrate with other ingredients in the solid formulation to form a hydrate solid or crystal lattice.

For shipping and sales purposes, the tablets may be wrapped in a horizontal form fill seal flow wrap made from Metallized Bi-Oriented Polypropylene (OPP) film laminated with polypropylene sealant film. Alternatively, the tablets may be wrapped in a 3 layer laminate flow wrap comprising an aluminum layer located between a polyethylene (PE) layer and a polyethylene terephthalate (PET) layer. As shown in the examples that follow, the 3-layer laminate flow wrap is preferred.

The solid compositions are dissolved in water to produce the disclosed cleaner and/or disinfectant solutions. Depending on the ingredients of the solid composition, the dissolution time may range from approximately 1 minute to approximately 60 minutes. The dissolution time is shorter when the formulation includes an effervescent agent, ranging from approximately 10 minutes to approximately 20 minutes. The speed of the effervescent reaction may be increased by increasing the temperature of the water. As disclosed in the examples that follow, the quantity of effervescent agent has been optimized to prevent too much foam generation.

The acidic solid compositions are dissolved in water to produce the disclosed cleaner and/or disinfectant solutions. The quantity of water should be sufficient to produce a cleaner and/or disinfectant solution comprising approximately 1.2% w/v to approximately 2% w/v citric acid and approximately 0.083% w/v to approximately 0.15% w/v sodium benzoate. In the examples that follow, 25 g of acidic solid composition was added to 750 mL water. When an effervescent is included, the resulting solution is low foaming. One of ordinary skill in the art will recognize that the quantity of solid composition and water volume may be changed without departing from the teachings herein. For example, two 12.5 g tablets may be used in 750 mL water. Alternatively, one (1) 10 g tablet may be added to 300 mL water.

The disclosed cleaner and/or disinfectant solutions reduce the microorganism load on a variety of hard surfaces, including but not limited to countertops, floors, walls, sinks, toilets, toilet bowls, bathtubs, and the like. Exemplary hard surfaces include surfaces made of bricks, cement, ceramic, crystal, diamond, fiberglass, glass, latex, linoleum, marble, metal, metal alloys, pebble, porcelain, polymers, quarry tiles, natural stone, wood, and mixtures thereof.

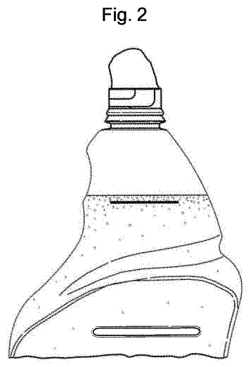

Also disclosed are cleaner and disinfectant kits and refills. The kit includes the disclosed solid cleaning and/or disinfecting compositions and a bottle having a fill line. The bottle may be glass, plastic, or any other material capable of containing a liquid. A picture of one exemplary bottle is provided in FIG. 2. Preferably the bottle material is suitable for repeated refilling. Stability testing of Example 9 demonstrates the solution produced from the solid cleaning and/or disinfecting composition does not react with polyethylene terephthalate (PET) bottles. The fill line is at a volume sufficient to obtain a cleaning and disinfectant solution comprising approximately 1.2% w/v to approximately 2% w/v citric acid and approximately 0.083% w/v to approximately 0.15% w/v sodium benzoate. In FIG. 2, the fill line is indicated by a magic marker. One of ordinary skill in the art will recognize that any form of marking may be used in the teachings herein, including labels, colored lines, etched or scored glass or plastic, change in bottle shape, and/or ridges or seams. The bottle may be transparent or translucent in order to better see the fill line, but transparency or translucency is not mandatory. The bottle may further comprise a spray trigger that delivers approximately 0.75 mL to approximately 3 mL of liquid/stroke, preferably approximately 1 mL to approximately 2 mL/stroke, and more preferably approximately 1.3 mL of liquid/stroke. One of ordinary skill in the art will recognize that effective germ kill is obtained when the surface is sprayed until wet, irrespective of the volume of solution delivered by the spray trigger.

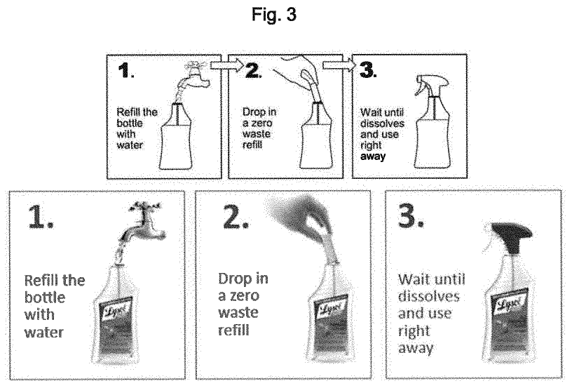

FIG. 3 is a flow chart demonstrating the method of using the disclosed kits. In FIG. 3-Step 1, water is added to the fill line. Exemplary tablet(s) is(are) added to the bottles in FIG. 3-Step 2. The tablet(s) dissolves in the water in approximately 15 minutes. Alternatively, the tablets may be added to the bottles prior to adding the water. One of ordinary skill will recognize that this will increase the concentration of the ingredients due to the volume displacement caused by the tablet. In other words, the fill line no longer represents the full volume calculated due to the volume displacement caused by the tablet(s). The spray trigger is placed on the bottle in FIG. 3-Step 3. As shown in the examples, the foam does not overflow for the preferred formulation E6, so the spray trigger can be placed on the bottle before dissolution is complete. However, it is preferred to wait to verify that dissolution is complete before adding the spray trigger. The cleaning and disinfectant solution may be used as soon as the tablet finishes dissolving. As shown in Example 9, the cleaning and disinfecting solution remains stable after two weeks at 54° C. and is expected to remain stable for up to two years at room temperature and humidity.

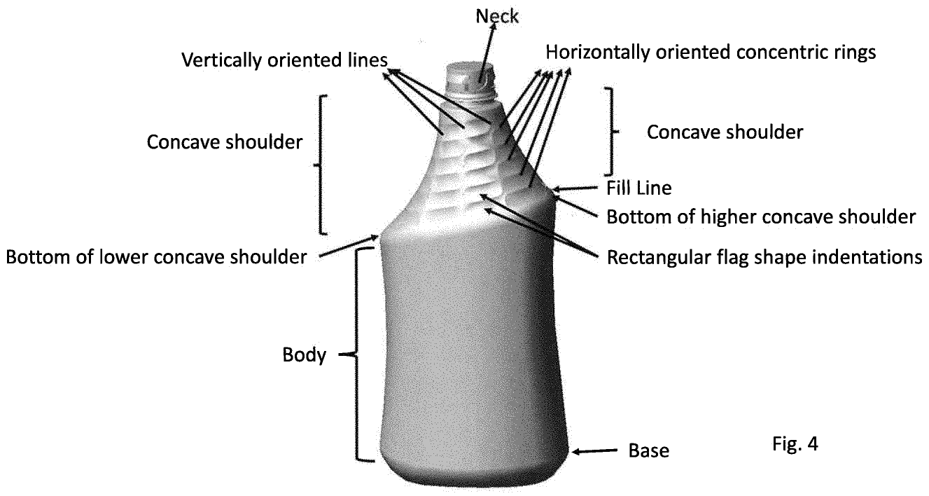

FIG. 4 is a front perspective view of the bottle used in the disinfectant kits disclosed above. The bottle comprises a neck connected to a body via a concave shoulder. The junction between the shoulder and bottle is inclined so that the junction is higher on one side of the bottle than on the other. As a result, the bottom of the concave shoulder is higher on one side of the bottle than on the other. This is depicted in FIG. 4 as the bottom of the lower concave shoulder and the bottom of the higher concave shoulder. The fill line of the bottle is at the bottom of the higher concave shoulder. The shoulder occupies between approximately 5% to approximately 15% by volume of the bottle and approximately 20% to approximately 30% by vertical linear area of the bottle.

The horizontal diameter at the base of the bottle is longer than the horizontal diameter at any other diameter of the bottle. This configuration permits the bottle to be locked into the carton used for sale or delivery. In other words, the base of the bottle locks into the carton used for sale, preventing consumers from removing bottles from shelf displays.

As shown in FIG. 4, the shoulder is patterned by horizontally oriented concentric rings that run parallel to the slope between the lower and higher shoulders; vertically oriented lines parallel to the concave shoulder; and indentations formed between the concentric rings and vertically oriented lines. This pattern provides improved ergonomics, specifically a better grip of the bottle whether wet or dry. When the bottle is 100% post consumer recycled (PCR) polyethylene terephthalate (PET), this pattern also shows different shapes at different angles. With the disinfectant compositions disclosed herein, the 100% PCR PET bottle may be reused between 1 and 100 times, preferably between 10 and 30 times, before it begins to break down and need recycling. Alternatively, the bottle may be formed from a compostable and recyclable waterproof paper laminate material, such as those disclosed in PCT Pub No WO2022/027047 to Procter & Gamble, WO2022/026716 to Frito-Lay North America Inc., or WO2020/178798 t Greentech Global PTE Ltd.

The bottle further comprising a neck that receives trigger sprayer. The trigger sprayer may be a snap-on, screw-on, hybrid snap-on/screw-on, or friction fit trigger. The trigger sprayer may have child resistant functionality. The trigger delivers approximately 0.75 mL to approximately 3 mL of liquid/stroke, preferably approximately 1 mL to approximately 2 mL/stroke, and more preferably approximately 1.3 mL of liquid/stroke.

Also disclosed are detergent packs containing any of the disinfectant compositions disclosed above. The detergent packs comprise a three-layer laminate material. The three-layer laminate material comprises an aluminum layer located between a polyethylene (PE) layer and a polyethylene terephthalate (PET) layer. The PE layer is in contact with the disclosed disinfectant compositions. The three-layer laminate material comprises an aluminum layer having a thickness ranging from approximately 6 microns to approximately 10 microns, preferably ranging from approximately 7 microns to approximately 9 microns; a PE layer having a thickness ranging from approximately 28 microns to approximately 32 microns, preferably from approximately 29 microns to approximately 31 microns; and a PET layer having a thickness ranging from approximately 10 microns to approximately 14 microns, preferably from approximately 11 microns to approximately 13 microns.

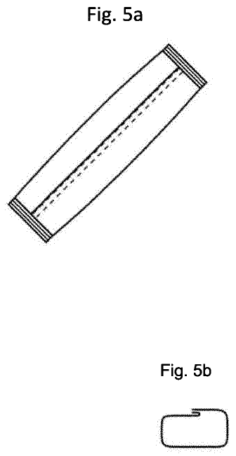

The detergent pack or packaging container is known as a pillow pack. The pillow pack is formed by three seams in overlapping portions of the three-layer laminate material, a top seam which spans a width at one end, a bottom seam that spans the width at the opposite end, and a side seam that spans a length between the end seams. FIG. 5a is a top view of the tubular pillow pouch that is formed from the three-layer laminate material and holds the disinfectant compositions disclosed herein. FIG. 5b is a side view of the tubular pillow pouch. The pillow packs are known to exhibit sealing failure as compared to alternative sealing patterns, such as the laminate fold overs with 3 or 4 sides sealed. Seal failure is obviously problematic for the hygroscopic citric-acid containing formulations. As shown in the examples that follow, the disclosed disinfectant compositions were stable in the 3 layer laminate pillow packs, but were not stable in pillow packs formed from flow wrap made from Metallized Bi-Oriented Polypropylene (OPP) films.

Powdered or tableted disinfectant composition may be contained in the tubular pillow pouch. The tubular pillow pouch may contain between 1 and 12 disinfectant tablets, preferably between 2 and 9 disinfectant tablets, more preferably between 3 and 6 disinfectant tablets, and most preferably 3 or 4 disinfectant tablets. The tubular pillow pack measures approximately 110 mm to approximately 130 mm long by approximately 20 mm to approximately 30 mm wide when it contains three tablets weighing between approximately 5 g and approximately 15 g, preferably between approximately 7.5 g to approximately 12.5 g. When the tubular pillow pack contains the acidic disinfectant tablets disclosed above, each of the three tablets preferably weighs between approximately 7.5 to approximately 10 g. When the tubular pillow pack contains the basic disinfectant tablets disclosed above, each of the three tablets preferably weighs between approximately 10 to approximately 12 g.

Alternatively, the disclosed solid cleaner and/or disinfectant composition and/or solution may be provided with a carrier substrate, e.g., a wipe type product or article. Unlike quaternary germicides, citric acid is not known to bind to nonwoven substrates, leaving it chemically available to perform germ kill action. A suitable amount of solid composition may be provided with a set of dry wipes and wipes dispensing canister having a fill line. As above, the water is added to the fill line and the solid composition added to the water. After dissolution, the wipes can be added to the resulting solution. Alternatively, the solution and wipes may be combined in a wipes dispensing package.

Advantageously, fibrous materials formed of natural and/or synthetic fibers may be used. The nonwoven fabrics may be a combination of viscose, lyocell, wood pulp fibers and textile length synthetic fibers formed by dry-form or wet-lay processes. Synthetic fibers such as nylon, orlon, polyester, and polypropylene as well as blends thereof may be employed. Such may be woven, or nonwoven, wipes or pads. Such may be spunlace, spunbond, wetlaid, resin bonded, hydroentangled, thermally bonded, meltblown, needlepunched, or any combination of the former. The substrate of the wipe may also be a film forming material such as a water-soluble polymer. Such film substrates may be sandwiched between layers of fabric substrates and heat sealed to form a useful substrate. The films themselves can be extruded utilizing standard equipment to devolatilize the blend. Casting technology can be used to form and dry films, or a liquid blend can be saturated into a carrier and then dried in a variety of known methods.

Suitable pads or wipes may have little or no content of cellulosic materials. Alternatively, pads or wipes that are predominantly (e.g., in excess of 50%) based on cellulosic fibers may be used. Particularly preferred are pads or wipes based on natural fiber sources, such as cotton or pulp, due to their efficacy, ready availability, and low cost. More preferably the pads or wipes contain at least 60%, and in order of increasing preference, at least 75%, 80%, 85%, 90%, 95%, 97%, 98%, 99%, and 100% based on cellulosic fibers. Closed cell or open celled foams are also useful as a pad or wipe. Such foams include polyurethane foams and regenerated cellulose foams, which may also be referred to as sponges.

Exemplary commercially available wipes include 100% regenerated cellulose at 45 or 70 grams per square meter (GSM) supplied by Spuntech Industries Inc.; 100% viscose at 35 or 40 GSM supplied by Sandler AG; 50% polypropylene and 50% pulp at 40 GSM supplied by Berry Global Inc.; 65% Pulp and 35% Polypropylene at 35 GSM supplied by Suominen Corp; 50% w/w viscose & 50% ww polyethylene terephthalate at 45 GSM supplied by Spuntech Industries Inc.; 51.1% w/w wood pulp, 26.7% w/w polypropylene, & 22.2% polyethylene terephthalate at 45 GSM supplied by Suominen Corp; 41.73% wood pulp, 40.27% polypropylene, and 18% polyethylene terephthalate at 55 GSM supplied by Suominen Corp & Atex Inc.; and 100% polypropylene at 45 and 55 GSM supplied by PF Nonwovens Czech s.r.o.

Any of the foregoing wipe type product or wipe article may include a laminate layer, such as a liquid impervious layer which may be useful in limiting the wicking of the treatment composition to a part or surface of the pad, wipe, or sponge.

Preimpregnated wipes may be provided at any useful loading ratio of disclosed cleaner and disinfectant solution: non-impregnated pad or wipe, but preferably such are loading ratio is the range of about 0.1-5:1 wt./wt, preferably 0.5-5:1 wt./wt.

The cleaning and disinfecting solution provides a 5 log₁₀ reduction in Staphylococcus aureus on a hard surface in approximately 10 minutes, preferably in approximately 5 minutes, and more preferably in approximately 2 minutes. Applicants believe that similar results will be obtained from typical infection micro-organisms, including Salmonella typhi and non-enveloped viruses.

The surface may be wiped to remove any residual liquid after 2, 5, or 10 minutes. Applicants believe that the formulation will not leave any residual stickiness. Testing to confirm streaking is planned to verify this non-quantified R&D results.

In addition to germ kill, the disclosed cleaning and disinfecting solution provides superior cleaning results, as shown in the examples that follow. More particularly, the disclosed solutions provide loose grease, CSPA soapscum, and lime scale removal equivalent or superior to commercially available formulations.

One of ordinary skill in the art will recognize that concentrated formulations that provide both germ kill and cleaning are typically expensive. Concentrated formulations typically require more raw materials to obtain suitable germ kill and cleaning. The disclosed solid compositions successfully balance the raw material cost requirement while maintaining product efficacy.

The following examples illustrate exemplary embodiments of the invention. It is to be understood that these examples are provided by way of illustration only and that further embodiments may be produced in accordance with the teachings of the present invention.

### EXAMPLES

The compositions in the following examples were prepared using the ingredients identified in Table A:

TABLE A

| Abbreviation | CAS | Description |
|---|---|---|
| SLS | 151-21-3 | Powdered sodium lauryl sulfate, e.g., Texapon K12P, Texapon |
| | | K12G or Stepanol WA100 |
| CA | 77-92-9 | Citric acid (≥96%) encapsulated in maltodextrin (≤2%), e.g., |
| | | Citric Acid DC from JBL |
| SCarb | 497-19-8 | Sodium carbonate Grade 100 |
| KCarb | 584-08-7 | Potassium carbonate powder, technical grade |
| SBicarb | 144-55-8 | Sodium bicarbonate |
| MGDA | 164462-16-1 | Methylglycine diacetic acid trisodium salt or trisodium |
| | | N-iminodiacetate or trisodium alpha-DL-alanine diacetate, e.g., |
| | | Trilon M Granules from BASF (80%) |
| SBenz | 532-32-1 | Sodium benzoate |
| F | Various | Fragrance |
| D | Various | Dye |
| EO5 | 127036-24-2 | Undecyl alcohol ethoxylate, with 5 moles ethoxylate e.g., |
| | | Makon ™ UD-5 from Stepan |
| EO6 | 127036-24-2 | Undecyl alcohol ethoxylate, with 6 moles ethoxylate (>99% |
| | | active), e.g., Makon ™ UD-6 from Stepan |
| EO8 | 127036-24-2 | Undecyl alcohol ethoxylate, with 8 moles ethoxylate, e.g., |
| | | Makon ™ UD-8 from Stepan |
| BTC | 85409-23-0 | Mixture of C12-14 alkyl dimethyl ethylbenzyl ammonium |
| | and | chloride (20% active) and C12-18 alkyl dimethyl benzyl |
| | 68391-01-5 | ammonium chloride (20% active) in an inert matrix, e.g., BTC |
| | | 2125M P40 in urea having 117 μm average particle size from |
| | | Stepan |

### Example 1: pH, Dissolution Time, and Foam Height of Acidic Formulations

The ingredients in Table 1 were mixed in a plastic bag. The mixture was weighed and placed in tablet mould. The tablet was handpressed using a tablet press. This was repeated twice for each formulation. 750 mL (25.4 ounces) tap water was heated to 50° C. in 800 mL bottles. Three (3) tablets of each formulation E1-E6 having an average weight of 24-26 g was added to tap water in separate bottles labelled to reflect the E1-E6 formulation contained therein. No mixing was required due to the effervescent properties of the tablets. The dissolution time was measured. Any foam overflow was also noted. FIG. 2 is an exemplary picture of a positive foam overflow result. The pH was measured on tablets dissolved in 750 mL (25.4 ounces) room temperature deionized water. The formulations and test results are provided in Table 1:

TABLE 1

| Abbreviation | E1 | | E2 | | E3 | | E4 | | E5 | | E6 | | E7 | |
|---|---|---|---|---|---|---|---|---|---|---|---|---|---|---|
| SLS (96% | 15.2 | (14.6) | 15.62 | (15.0) | 12.03 | (11.5) | 16.91 | (16.2) | 14.78 | (14.2) | 16.32 | (15.7) | 13.2 | (12.7) |
| active level) | | | | | | | | | | | | | | |
| CA (96% | 51.29 | (49.2) | 52.70 | (50.6) | 54.94 | (52.7) | 57.08 | (54.8) | 55.10 | (52.9) | 55.08 | (52.9) | 64.31 | (61.7) |
| active level) | | | | | | | | | | | | | | |
| SCarb | 0 | | 11.54 | | 12.03 | | 4.17 | | 9.05 | | 7.54 | | 0 | |
| SBicarb | 13.89 | | 0 | | 0 | | 0 | | 0 | | 0 | | 6.05 | |
| MGDA (76% | 7.4 | (5.6) | 7.6 | (5.8) | 7.92 | (6.0) | 8.23 | (6.3) | 7.95 | (6.0) | 7.95 | (6.0) | 6.9 | (5.2) |
| active level) | | | | | | | | | | | | | | |

| SBenz | 3.75 | 3.86 | 4.02 | 4.18 | 4.03 | 4.03 | 3.83 |
|---|---|---|---|---|---|---|---|
| F | 8.44 | 8.66 | 9.02 | 9.40 | 9.05 | 9.05 | 5 |
| D | 0.03 | 0.03 | 0.03 | 0.03 | 0.03 | 0.03 | 0.0263 |
| EO6 | 0 | 0 | 0 | 0 | 0 | 0 | 0.69 |
| pH | NR | NR | NR | 2.93 | NR | 3.25 | 2.83 |
| Dissolution | 15 | 15 | 15 | Did not | 14 | 15 | 13 |
| Time | minutes | minutes | minutes | completely | minutes | minutes | minutes |
| | | | | dissolve | | | |
| Foam | Yes, | Yes | Yes | No | Yes | No | NR |
| Overflow? | from | | | | | | |
| | 13-15 | | | | | | |
| | minutes | | | | | | |
| Other | | Final | | At 40 | Slightly | Clear | Clear |
| | | solution | | minutes, | cloudy | formulation | formulation |
| | | is cloudy | | large | formulation | | |
| | | | | particles | | | |
| | | | | remained | | | |

NR = Not recorded

As can be seen from Table 1, higher concentrations of sodium bicarbonate or carbonate resulted in foam overflowing the top of the bottle. Foam overflow produces a negative consumer experience because the cap or spray trigger cannot immediately be placed on the container without producing a mess. Water and cleaning material may also be lost, negatively affecting efficacy of the cleaner. In contrast, too low of a concentration of sodium carbonate led to longer tablet dissolution times as shown for formulation E4. This effect is also not desirable because the consumer will question whether the solution has reached full cleaning potential. Consumers prefer clear or transparent cleaning solutions, not cloudy solutions. Formulation E6 provided the best results.

### Example 2: Citric Acid

R&D formulations similar to Formula E1 in Example 1 were tested using citric acid anhydrous or citric acid coated with sodium citrate sold as Citrocoat™ N by Jungbunzlauer (JBL). Citric acid anhydrous was too hygroscopic for use in a tablet formulation. During stability testing, the size of the tablets increased, demonstrating water absorption. Citric acid coated with sodium citrate did not exhibit suitable tableting qualities, separating into loose powder after removal from the tablet mould. As a result, Applicants believe that sodium citrate coatings will not provide sufficient binding capabilities due at least partially to higher melting points (300° C.) than maltodextrin (260° C.).

### Example 3: Disinfecting Analysis

Applicants have surprisingly discovered that the germ kill efficacy of citric acid is significantly enhanced by the addition of sodium benzoate. It is known that limited to no germ kill results from sodium benzoate or citric acid solutions at pH ranging from 5-8 and that germ kill increases as pH decreases. Adamczak et al disclosed that a 1 mg/mL solution of citric acid in a 20% dimethyl sulfoxide water solution was inactive against Staphyloccocus aureus. Antibacterial Activity of Some Flavonoids and Organic Acids Widely Distributed in Plants, J. Clin. Med., 2020, 9, 109.

In dilution, formula E6 produces 1.3% w/v active citric acid (1.3 g/mL±192.2 g/mol×1000 mL/L=6.8 M) and 0.13% w/v sodium benzoate at a pH of 3.25. After a 10 minute contact time, the total number of positive test results/the total number of samples tested for Formula E6 were 0/60 against Staphylococcus aureus (ATCC 6538) using the Association of Official Analytical Chemists International (AOAC) 961.02 Germicidal Spray Products as Disinfectants (GSP) test in dirty conditions. As is well known in the art, S. aureus is one of the harder organisms for organic acids to kill and therefore indicative that this formulation will also be successful against other organisms. See, e.g., supra Adamczak et al. A previous dilution containing 1.25% w/v active citric acid and 0.26% w/v sodium benzoate produced 0/60 against both S. aureus and S. enterica after 10 minutes contact time. Applicant expects that formulations of 1.3% w/v citric acid with no sodium benzoate will struggle to successfully kill S. aureus.

The formulations in Table 2 were prepared in order to better evaluate the synergistic effect obtained by the combination of citric acid and sodium benzoate.

TABLE 2

| Abbreviation | C1 (g) | C2 (g) | C3 (g) |
|---|---|---|---|
| SLS (96% active level) | 4.09 | 4.08 | 4.10 |
| CA (96% active level) | 13.77 | 2.27 | 0 |
| SCarb | 1.88 | 1.89 | 1.88 |
| MGDA (76% active level) | 1.99 | 1.99 | 2.00 |
| SBenz | 0 | 1.00 | 1.01 |
| F | 2.26 | 2.25 | 2.24 |
| D | 0.008 | 0.0085 | 0.0070 |
| X g added to 750 mL tap | 24.00 g | 13.49 g | 11.23 g |
| H2O | | | |
| Concentration of CA in soln | 1.5 | 0 | 0 |
| Concentration of SBenz in | 0 | 0.13 | 0.13 |
| soln | | | |
| pH of Dilution | 3.13 | 7.05 | 11.05 |
| AOAC GSP | 30/30** | 0/30** | 60/60*** |

*Mostly consumed during effervescence
**10 minute contact time against ATCC 6538 in dirty conditions
***5 minute contact time against ATCC 6538 in dirty conditions

One of ordinary skill in the art will recognize that removal of the citric acid or sodium benzoate from these test formulations increases the total weight percent of the remaining ingredients. As a result, the same weight of material was used in all three formulations, with the size of the sample added to tap water changed to reflect the material change. Doing so ensures that the same amount of material is compared so that the only change is in the level of active ingredients.

As can be seen in Table 2, the pH of C2 remains below 7.5 even though all of the citric acid is consumed during effervescence. Applicants believe that some sodium citrate may remain in the formulation as demonstrated by the neutral pH. In contrast, without any citric acid in formula C3, sodium benzoate at the same concentration does not provide any germ kill. Similarly, formula C1 without any sodium benzoate does not provide any germ kill. These results demonstrate the synergistic germ kill effect obtained by the combination of citric acid and sodium benzoate.

These results lead Applicant to believe that these formulations containing the combination of citric acid and sodium benzoate may also successfully be used to kill enveloped viruses, such as Herpesviridae and Pleolipoviridae. Additional micro testing results are provided in Example 10 infra.

### Example 4: Loose Grease Cleaning Efficacy of Acidic Formulations

A comparison was made of the loose grease cleaning efficacy of Formula E1, E5, water, two R&D formulations (C5 and C7), and two commercially available formulations (C4 and C6) of Table 3.

TABLE 3

| Ingredients* | C4 | C5 | C6 | C7 |
|---|---|---|---|---|
| SLS (96% active level) | — | 13.94 (13.38) | — | — |
| C8-C18 Alkyl dimethyl benzyl ammonium chloride | x | — | — | — |
| C12-C16 Alkyl dimethyl benzyl ammonium chloride | x | — | — | — |
| C12-C18 Alkyl dimethyl benzyl ammonium chloride | — | — | — | 2.4 |
| C12-C14 Alkyl dimethyl ethylbenzyl ammonium chloride | — | — | — | 2.4 |
| Lauramine Oxide | x | — | — | — |
| C6-C10 Alcohols Ethoxylated Propoxylated | — | — | x | — |
| C11 branched alcohol ethoxylate | — | — | — | 7.999 |
| Sodium Lauryl Sulfate | — | — | x | — |
| Disodium decyl phenyl ether disulfonate | — | — | x | — |
| Citric Acid** | — | 34.33 (32.96) | x | 11.99 (11.51) |
| Sulfomic Acid | — | 19.73 | | — |
| Trisodium Dicarboxymethyl Alaninate | x | — | — | — |
| Phenoxyisopropanol | x | — | — | — |
| Dipropylene Glycol Butyl Ether | — | — | x | — |
| SBicarb | — | 17.07 | — | — |
| SCarb | — | — | — | 51.995 |
| MGDA | — | — | — | 7.999 |
| Glycolic Acid | — | — | x | — |
| Ethanolamine | x | — | — | — |
| SBenz | — | 4.59 | — | — |
| Fragrance | x | 10.33 | x | 7.999 |
| Dye | — | 0.02 | — | 0.009 |
| Water | x | — | x | |

*Product ingredients obtained from company websites.
**C5 and C7 used the same CA as in the examples above.

The method used is based on ASTM D4488 A2—Standard Guide for Testing Cleaning Performance of Products Intended for Use on Resilient Flooring and Washable Walls

Fine porosity cellulose sponges are cut to 4.445 cm (1.75 inches) by 9.2075 cm (3.625 inches) by 3.81 cm (1.5 inches). The sponges are rinsed and spun three times using warm water only in a Maytag washing machine to ensure that the sponges are free of contaminants/preservatives and to establish uniform dampness for all sponges. The sponges are then placed in a tightly sealed bag in order to maintain dampness until ready for use.

0.3175 cm (0.125 inch) by 11.43 cm (4.5 inch) by 11.43 cm (4.5 inch) Masonite wallboard is double coated with a latex paint and allowed to set overnight. The reflectance of the white tile before soiling is measured and recorded as R3.

The soil to be cleaned is freshly prepared each day in a 600 mL Pyrex® beaker in a 55° C. steam bath. 33% w/w vegetable shortening, 33% w/w vegetable oil, 33% w/w lard, and 1% w/w carbon lampblack are mixed in the heated beaker.

Cheesecloth is folded in half several times to produce a 6.35 cm (2.5 inch) by 5.08 cm (2 inch) piece. A binder clip is placed along the 6.35 cm edge of the folded cheesecloth.

Using the clip as a handle, soak the cheesecloth in the hot soil and apply the soil to the white-painted Masonite wallboard tiles using six strokes. The soil temperature should be maintained, and the soil should be stirred throughout the application process. Allow the soiled substrate to dry overnight at room temperature. The reflectance of the soiled tile is measured by either a tri-gloss meter, e.g., from BYK Gardner, or digital imaging, e.g., a digital monochrome camera using suitable software, such as Image Pro Plus, and recorded as R2.

Each tile is divided in two equal halves using masking tape. The tiles are numbered and the treatment each side will receive is indicated.

The soiled tile is placed on the platform of the Gardner Abrasion Tester (without tray) in such a manner that the soiled part of the tile is perpendicular to the direction of the sponge motion, so that the sponge will scrub an area centered within one half of the tile.

The sponge is placed in the holder and 15 grams of test product is poured onto the sponge. One half of the tile is scrubbed x times and immediately rinsed with cold running tap water. The tile position is reversed to repeat the process on the other half of the tile with a new sponge and product sample. The reflectance of the cleaned tile is measured and recorded as R1.

The percent cleaning efficiency is measured as [(R1-R2)/R3-R2)]×100. The test is repeated for each formulation 3 times. The results are provided in Table 4.

TABLE 4

| | E1 | C4 | C5 | C6 | C7 | Water |
|---|---|---|---|---|---|---|
| Loose Grease | 51.19 | 52.39 | 43.38 | 37.97 | 21.81 | 9.42 |

The results show the percentage of soil removed from the tile. Higher percentages indicate better cleaning. C4 is considered one of the best loose grease cleaners available on the market. As can be seen, Formulation E1 provided comparable cleaning results. Formula E1 is also superior to Formula C5, which has similar ingredients.

While Formula E1 differs in foam generation from Formula E6, the cleaning structure is similar and similar loose grease cleaning results are expected from Formula E6. More specifically, all of the sodium carbonate or sodium bicarbonate is consumed during production of the carbon dioxide effervescent bubbles and, as a result, does not contribute to cleaning efficacy.

### Example 5: CSPA Soapscum Removal of Acidic Formulations

A comparison was made of the soapscum removal efficacy of Formula E1, water, and three different cleaning formulations of Table 3.

The soapscum removal efficacy was based on CSPA Designation DCC 16 Part 2.

A 10.76 cm×10.76 cm Black Bathroom Tile is cleaned using ethanol and allowed to dry overnight in 105° C. oven. The reflectance of the surface of this tile is read by either a tri-gloss meter, e.g., from BYK Gardner, or digital imaging, e.g., a digital monochrome camera using suitable software, such as Image Pro Plus and recorded as R3.

A Parent soil is created in a 600 mL Pyrex® beaker in a 55° C. steam bath. 3.90% w/w Stearic Acid Soap Bar, 0.35% w/w shampoo (moderate alkyl ethoxylate containing with no conditioner), 0.06% w/w Black Charm Clay, 0.15% w/w Artificial Sebum, and 95.54% w/w Hard Water. The final soil is mixed on the day of application. The final mixture is 4.50% w/w Parent Soil, 9.00% w/w Hard Water 0.77% w/w Hydrochloric Acid 0.1N, and 85.73% Acetone. This is homogenized for 30 minutes.

The tiles are cooled to room temperature and weighed.

The tiles are placed on a slant board. The soil applied in a continuous motion using an airbrush until the amount of soil on the tile weighs between 0.10 g and 0.15 g. The tiles are air dried for 15-30 minutes and re-weighed to verify that the weight remains in the above stated ranged.

Tiles are then heated for 25-30 min in a 205° C. oven, or until the tiles have a dull surface sheen. Once cooled the reflectance of the tile is measured and recorded as R2.

Each tile is divided in two equal halves using masking tape. The tiles are numbered and the treatment each side will receive is indicated.

The soiled tile is placed on the platform of the Gardner Abrasion Tester (without tray) in such a manner that the soiled part of the tile is perpendicular to the direction of the sponge motion, so that the sponge will scrub an area centered within one half of the tile.

The sponge is placed in the holder and 2.0 grams of test product is poured onto the tile surface using a disposable pipette. Allow a 30 second contact time to cleaning. One half of the tile is scrubbed 10 times and immediately rinsed with cold running tap water. The tile is dried using pressurized air. The tile position is reversed to repeat the process on the other half of the tile with a new sponge and product sample. The reflectance of the cleaned tile is measured and recorded as R1.

The percent soapscum removal is measured as [(R1−R2)/R3−R2)]×100. The test is repeated for each formulation 3 times. The average of the four results is provided in Table 5.

TABLE 5

| | E1 | C4 | C5 | C7 | Water |
|---|---|---|---|---|---|
| Soapscum Removal | 29.5 | 9.82 | 16.18 | 10.5 | 13.0 |

As can be seen, Formula E1 provides better soapscum removal than all of the comparative examples.

While Formula E1 differs in foam generation from Formula E6, the cleaning structure is similar and similar soapscum removal results are expected from Formula E6. More specifically, all of the sodium carbonate or sodium bicarbonate is consumed during production of the carbon dioxide effervescent bubbles and, as a result, does not contribute to cleaning efficacy.

### Example 6: Limescale Removal of Acidic Formulations

A comparison was made of the limescale efficacy of Formula E1, water, and the four different cleaning formulations of Table 3.

The following process was performed to determine limescale removal efficacy.

1.9 cm (0.75 inch)×1.9 cm (0.75 inch)×0.95 cm (0.375 inch) marble cubes were rinsed thoroughly with deionized water and dried for one hour at 105° C. in an oven. 4 marble cubes are tested for each product sample.

5 cm (2 inch) aluminum pans are labeled and weighed using an analytical balance. The label and weights are recorded as the tare weight. A marble cube is placed in the pan, polished side up, and reweighed, with the weight recorded. The initial weight is the weight of the marble cube in the pan minus the weight of the pan (tare weight).

Approximately 40 grams of test product is placed in a glass or suitable container. The size of the glass or container must be large enough to completely submerge the marble in the test product. The marble cube is completely submerged in the test product using forceps, with polished side facing up. The marble cube is soaked in the test product for one minute. The marble cube is removed from the test product and immediately submerged in a beaker of deionized water. The marble cube is then placed on a perforated spoon and rinsed with deionized water for 30 seconds. The marble cube is placed back in its aluminum pan and dried for one hour at 105° C. The marble cubes are then allowed to cool in a dessicator and re-weighed. The final weight is the weight of the marble cube in the pan after testing and drying minus the weight of the pan (tare weight).

The percent lime scale dissolved is measured as [(Initial weight−Final weight)/Initial weight]×100.

The average of the four test results is provided in Table 6.

TABLE 6

| | E1 | C4 | C5 | C6 | C7 | Water |
|---|---|---|---|---|---|---|
| Limescale Removal | 87.91 | 54.3 | 84.90 | 83.32 | 51.76 | 33.33 |

As can be seen, Formula E1 provides better lime scale removal than all of the comparative examples.

While Formula E1 differs in foam generation from Formula E6, the cleaning structure is similar and similar lime scale removal results are expected from Formula E6. More specifically, all of the sodium carbonate or sodium bicarbonate is consumed during production of the carbon dioxide effervescent bubbles and, as a result, does not contribute to cleaning efficacy.

### Example 7: Tablet Stability of Acidic Formulations

Accelerated storage stability and corrosion studies were performed on tablets having formulation E6. The studies were conducted by an independent laboratory in compliance with the U.S. Environmental Protection Agency Good Laboratory Practice (GLP) regulations codified at 40 CFR Part 160. The tablets tested included (3) different fragrance variants, identified as E6-1, E6-2, and E6-3 in Table 7 below. Three (3) tablets having the same fragrance were contained in one (1) flow wrap pack. The tablets in the flow wrap packaging were stored at 54±2° C. for fourteen (14) days. The corrosion characteristics (identified as “Corrosion” in Table 7 below) were determined by two different individuals and included a visual examination of the container for evidence of corrosion. The physical assessment (identified as “Physical” in Table 7 below) was determined by two different individuals and included a visual inspection of a portion of the tablet in a small weigh boat. Analysis for any phase separation and/or clumping was included in the physical assessment review. The laboratory performed a full method validation of the assay used to determine the citric acid concentration. The assay result was calculated from the average of the assays for each of the three (3) tablets contained in the flow wrap package.

TABLE 7

| Test and Time | E6-1 | E6-2 | E6-3 |
|---|---|---|---|
| Day 0 Weight | 25.88 g | 25.86 g | 25.85 g |
| Day 14 Weight | 25.20 g | 25.19 g | 25.27 g |
| Day 0 Corrosion | None | None | None |
| Day 14 Corrosion | None | None | None |
| Day 0 Physical | Dry cylindrical | Dry cylindrical | Dry cylindrical |
| | solid with no | solid with no | solid with no |
| | phase separation | phase separation | phase separation |
| | or clumping | or clumping | or clumping |
| Day 14 Physical | Dry cylindrical | Dry cylindrical | Dry cylindrical |
| | solid with no | solid with no | solid with no |
| | phase separation | phase separation | phase separation |
| | or clumping | or clumping | or clumping |
| Day 0 Assay | 55.02% | 54.32% | 55.11% |
| | Citric Acid | Citric Acid | Citric Acid |
| Day 14 Assay | 54.34% | 55.50% | 54.39% |
| | Citric Acid | Citric Acid | Citric Acid |

The results in Table 7 demonstrate that tablets of formulation E6 will be stable for two (2) years at ambient storage conditions. Table 7 further demonstrates that the flow wrap packaging and tablet formulations successfully prevent weight gain due to water absorption from air (hygroscopicity).

### Example 8: Packaging Stability of Acidic Formulations

Accelerated storage stability and corrosion studies were performed on tablets having formulation E6. Three (3) tablets were contained in one (1) flow wrap pack. Two different flow wrap materials were tested. Flow wrap A in Table 8 below is a tri-layer flow wrap having an 8 micron thick Aluminum layer sandwiched between a 30 micron thick polyethylene layer and a 12 micron thick PET layer. The tablets were adjacent to the PE layer. Flow wrap B in Table 8 below is a 30 micron aluminum metallized oriented polypropylene film. The tablets were adjacent to the PP layer. Both Flow wrap A and B are commercially available in sheets that may be used to form the flow wrap pack. The flow wrap containers were formed by three seams in overlapping portions of the laminate material, a top seam which spans a width at one end, a bottom seam that spans the width at the opposite end, and a side seam that spans a length between the top and bottom seams, forming a tubular package measuring approximately 110 mm to approximately 130 mm long (i.e., measurement of side seam) by approximately 20 mm to approximately 30 mm wide (i.e., measurement of top or bottom seam). The tablets in the flow wrap packaging were stored at 40° C. and 75% relative humidity for eleven (11) weeks. As can be seen in Table 8 below, the Flow wrap B package exhibited significant weight increase, demonstrating moisture penetration and absorbance by the tablets. As time progressed, the appearance of tablets in flow wrap B changed due to moisture absorbance, exhibiting color change and surface texture changing from shiny to dull. No visual changes to the tablets occurred in Flow wrap A.

TABLE 8

| | Flow Wrap A | Flow Wrap B |
|---|---|---|
| Day 0 Weight | 19.4 g | 19.23 g |
| Week 1 Weight | 19.4 g | 19.23 g |
| Week 2 Weight | 19.32 g | 19.33 g |
| Week 3 Weight | 20.04 g | 20.01 g |
| Week 4 Weight | 19.4 g | 21.10 g |
| Week 5 Weight | 19.5 g | 19.04 g |
| Week 6 Weight | 19.6 g | 21.42 g |
| Week 7 Weight | 19.7 g | 19.53 g |
| Week 8 Weight | 19.8 g | 32.14 g |
| Week 9 Weight | 19.44 g | 42.1 g |
| Week 10 Weight | 19.55 g | 53.10 g |
| Week 11 Weight | 19.2 g | 52.54 g |

### Example 9: Solution Stability of Acidic Formulations

Accelerated storage stability and corrosion studies were performed on solutions prepared from tablets having formulation E6. The tablets tested contained the same fragrance as E6-2 in Table 7. The studies were conducted by an independent laboratory in compliance with the U.S. Environmental Protection Agency Good Laboratory Practice (GLP) regulations codified at 40 CFR Part 160. The test solutions were prepared by dissolving three (3) tablets in 750 mL of 400 ppm AOAC hard water in polyethylene terephthalate (PET) bottles. Nine (9) PET bottles containing the test solutions were stored at 54±2° C. for fourteen (14) days. The corrosion characteristics (identified as “Corrosion” in Table 9 below) were determined by two different individuals and included a visual examination of the container for evidence of corrosion. This analysis included a visual examination of lids, liners, seams, and container sides. The physical assessment (identified as “Physical” in Table 9 below) was determined by two different individuals and included a visual inspection of the solution in a 50 mL glass beaker. Analysis for any phase separation and/or clumping is included in the physical assessment review. The laboratory performed a full method validation of the assay used to determine the citric acid concentration. The assay was performed in triplicate for each bottle. The results in Table 9 are the average from three (3) different bottles, with the average of bottles 2 (1.48), 3 (1.46), and 4 (1.46) being used for the Day 0 Assay and the average of bottles 5 (1.6), 6 (1.49), and 7 (1.44) being used for the Day 14 assay.

TABLE 9

| Test and Time | E6-2 |
|---|---|
| Day 0 Weight* | 825.92 g |
| Day 14 Weight* | 822.95 g |
| Day 0 Corrosion | None |
| Day 14 Corrosion | None |
| Day 0 Physical | Liquid sample with no phase |
| | separation and no clumping |
| Day 14 Physical | Liquid sample with no phase |
| | separation and no clumping |
| Day 0 Assay | 1.47% Citric Acid |
| Day 14 Assay | 1.46% Citric Acid |

*Average of six (6) different bottles

The results in Table 9 demonstrate that solutions formed from tablets of formulation E6 will be stable for two (2) years at ambient storage conditions.

### Example 10: Micro Testing of Acidic Formulations

Micro efficacy testing studies against bacteria and viruses were performed using solutions prepared from tablets having formulation E6. The studies were conducted by an independent laboratory in compliance with the U.S. Environmental Protection Agency Good Laboratory Practice (GLP) regulations codified at 40 CFR Part 160. The test solutions were prepared by dissolving three (3) tablets in 750 mL of 400 ppm AOAC hard water in polyethylene terephthalate (PET) bottles with a spray trigger. The bottles were shaken to ensure homogeneity and sprayed to prime the spray trigger prior to testing. An average of 2.0 mL was produced from three (3) pump sprays.

Virus tests (ASTM International E1053-20): The solution was sprayed (three pump sprays) onto the virus carriers in a horizontal position from a distance of six to eight inches. A control carrier was not treated with the solutions. The carriers were held at the specified conditions and for the contact time specified in Table 10 below. A cell scraper was used to scrape the carriers just prior to the end of the exposure time in order to resuspend the contents. The contents were passed through a Sephadex column utilizing the syringe plungers in order to detoxify the mixtures. The filtrates were then tiered by 10-fold serial dilution and assayed for infectivity and/or cytotoxicity.

Bacterial tests (AOAC Germicidal Spray Method 961.02): Bacterium culture was uniformly spread over individual glass slide carriers contained in a Petri dish. The carriers were allowed to dry for 30 minutes. The test solution was sprayed (three pump sprays) onto the carriers from a distance of six to eight inches. A control carrier was not sprayed with the solution to confirm growth. After the five (5) minute contact time, the excess liquid was drained off the carrier without touching the carrier to the Petri dish or filter paper. All subcultures were intubated for 48 hours at 35-37° C. Following intubation, the subcultures were visually examined for presence or absence of visible growth.

TABLE 10

| Test Organism | Test Method | Results |
|---|---|---|
| 2009-H1N1 Influenza A Virus | ASTM Int'l | ≥6.25 log₁₀ reduction after five (5) minute |
| (Novel H1N1) | E1053-20 | contact time and 2% fetal bovine serum |
| Strain: A/Mexico/4108/2009 | | organic soil load at room temperature |
| CDC #2009712192 | | (21.0° C.) and 52.21% relative humidity (RH) |
| | | from two (2) different lots of tablets |
| Avian Influenza A (H3N2) | ASTM Int'l | ≥6.50 log₁₀ reduction after five (5) minute |
| Strain: A/Washington/897/80 | E1053-20 | contact time and 2% fetal bovine serum |
| x A/Mallard/New | | organic soil load at room temperature |
| York/6750/78 | | (20.5° C.) and 57.05% RH from two (2) |
| ATCC VR-2072 | | different lots of tablets |
| Escherichia coli | AOAC | No growth in any of the 10 carriers following |
| ATCC 11229 | Germicidal | a five (5) minute exposure time at room |
| | Spray Method | temperature (21° C.) and 43% RH by two (2) |
| | 961.02 | lots of tablets |
| Human adenovirus type 5 | ASTM Int'l | ≥6.45 log₁₀ reduction after five (5) minute |
| Strain: Adenoid 75 | E1053-20 | contact time and 2% fetal bovine serum |
| ATCC VR-5 | | organic soil load at room temperature |
| | | (22.0° C.) and 41.77% RH from three (3) |
| | | different lots of tablets |
| Human coronavirus | ASTM Int'l | ≥4.25 log₁₀ reduction after five (5) minute |
| Strain: 229E | E1053-20 | contact time and 2% fetal bovine serum |
| ATCC VR-740 | | organic soil load at room temperature |
| | | (20.0° C.) and 50% RH from two (2) different |
| | | lots of tablets |
| Influenza B Virus | ASTM Int'l | ≥4.75 log₁₀ reduction after five (5) minute |
| Strain: B/Hong Kong/5/72 | E1053-20 | contact time and 2% fetal bovine serum |
| ATCC VR-823 | | organic soil load at room temperature |
| | | (21.0° C.) and 52.50% RH from two (2) |
| | | different lots of tablets |
| Parainfluenza Virus 2 | ASTM Int'l | Complete inactivation after five (5) minutes |
| Strain: Greer | E1053-20 | contact time at 20° C. and 54% RH by two (2) |
| Source ATCC VR-92 | | different lots of tablets |
| Parainfluenza Virus 3 | ASTM Int'l | ≥6.00 log₁₀ reduction after five (5) minute |
| Strain: C243 | E1053-20 | contact time and 2% fetal bovine serum |
| ATCC VR-93 | | organic soil load at room temperature |
| | | (20.0° C.) and 73% RH from two (2) different |
| | | lots of tablets |
| Pseudomonas aeruginosa | AOAC | No growth in any of the 60 carriers following |
| ATCC 15442 | Germicidal | a five (5) minute exposure time at room |
| | Spray Method | temperature (22° C.) and 42% RH by three (3) |
| | 961.02 | lots of tablets |
| Respiratory syncytial virus | ASTM Int'l | ≥6.00 log₁₀ reduction after five (5) minute |
| Strain: Long | E1053-20 | contact time and 2% fetal bovine serum |
| ATCC VR-26 | | organic soil load at room temperature |
| | | (20.6° C.) and 52% RH from two (2) different |
| | | lots of tablets |
| Rhinovirus type 14 | ASTM Int'l | ≥4.50 log₁₀ reduction after five (5) minute |
| Strain: 1059 | E1053-20 | contact time and 2% fetal bovine serum |
| ATCC VR-284 | | organic soil load at room temperature |
| | | (22.0° C.) and 44.53% RH from two (2) |
| | | different lots of tablets |
| Salmonella enterica | AOAC | No growth in any of the 60 carriers following |
| ATCC 10708 | Germicidal | a five (5) minute exposure time at room |
| | Spray Method | temperature (22° C.) and 47% RH by three (3) |
| | 961.02 | lots of tablets |
| SARS-Related Coronavirus 2 | ASTM Int'l | ≥6.00 log₁₀ reduction after five (5) minute |
| Strain: Isolate USA-WA1/2020 | E1053-20 | contact time and 2% fetal bovine serum |
| BEI Resources NR-52281 | | organic soil load at room temperature |
| | | (21.62° C.) and 57.79% RH from three (3) |
| | | different lots of tablets |
| Staphylococcus aureus | AOAC | No growth in any of the 60 carriers following |
| ATCC 6538 | Germicidal | a five (5) minute exposure time at room |
| | Spray Method | temperature (22° C.) and 42% RH by three (3) |
| | 961.02 | lots of tablets |

The results in Table 10 demonstrate that the disclosed tablets form solutions that provide biocidal protection against bacteria and viruses, including hard to kill bacterium like S. aureus and viruses like rhinovirus. One of ordinary skill in the art would not expect this activity from the concentration of citric acid in the solution.

### Example 11: pH, Dissolution, and Foam Height of Basic Formulations

The Carb or Bicarb listed in Table 11 below was added to a rotary mixer and mixing commenced. Exemplary rotary mixers include Vidax™ or VH-14 mixers. One of ordinary skill in the art will recognize that mixing conditions will be dependent upon the batch size. For a 600 kg batch size in a stainless steel vessel, an exemplary suitable mixing speed may range from approximately 6 revolutions per minute (RPM) to 12 RPM, preferably from 8 RPM to 10 RPM. The liquid EO4 or EO6 was sprayed onto the mixing Carb or Bicarb. Mixing was continued until the mixture was visually uniform. After visual uniformity was obtained, CA was added to the mixture. Mixing is continued until the mixture was visually uniform. F, MGDA, D, and BKC were consecutively added to the mixture with continued mixing. Mixing was stopped when the batch was visually uniform. The powder density and flowability of the resulting mixture was analyzed. Applicants believe that core sample active assay testing will show that the individual components are uniformly distributed. This testing may or may not be performed on each and every batch. The resulting mixture has a density of approximately 0.8 g/cm³. The resulting powder was divided into allotments of the desired tablet weight. Each individual allotment was placed into a tablet mould. The tablet was handpressed using a tablet press.

750 mL (25.4 ounces) of tap water was heated to 50° C. and added to an 800 mL PET bottle. Two additional 800 mL PET bottles were prepared in the same manner. For each formulation, three (3) tablets having an average weight of 10 g each were added to the tap water in the bottle. No mixing was required due to the effervescent properties of the tablets. The dissolution time was measured. Any foam overflow was also noted. FIG. 2 is an exemplary picture of a positive foam overflow result. Due to the effervescence, the formulation is initially cloudy, but becomes clear after approximately one hour. The formulations and test results are provided in Table 11:

TABLE 11

| Raw Material | C8 | E8 | E9 |
|---|---|---|---|
| BKC | 11 (4.4) | 11 (4.4) | 11 (4.4) |
| CA | 12 | 12 | 12 |
| Bicarb | 50.37 | 0 | 0 |
| Carb | 0 | 50.37 | 50.37 |
| EO4 | 0 | 0 | 7.5 |
| EO6 | 7.5 | 7.5 | 0 |
| GLDA | 8.1 (6.5) | 8.1 (6.5) | 8.1 (6.5) |
| F | 11 | 11 | 11 |
| D | 0.03 | 0.03 | 0.03 |
| Dissolution time (in minutes) | ~7 | ~14-15 | ~14-15 |
| Foam overflow? | Yes | No | No |
| pH | ~7.5 | ~10 | ~10 |

As can be seen from Table 11, inclusion of sodium bicarbonate resulted in foam overflowing the top of the trigger bottle. Foam overflow produces a negative consumer experience because the cap or trigger cannot immediately be placed on the bottle without producing a mess. Water and cleaning material may also be lost, negatively affecting efficacy of the cleaner.

### Example 12: Baked on (Polymerized) Grease Removal Using Basic Formulations Soil Removal Testing

The compositions of Table 11 were tested for their efficacy in removing burnt-on deposits from hard surfaces, representative of those as are typically encountered on stovetops and oven surfaces. The following materials and protocols were used. Cleaning results are reported on the following tables.

### Standardized Soil Preparation:

### Part 1:

A 1 kg mixture of soil was prepared and used in the following tests. The soil was designed to mimic real-world burnt-on cooking stains. A premixture was formed which included approximately 40-45% w/w oil; approximately 10-17% w/w pie filling; approximately 25-35% w/w fatty ground meat; approximately 1-3% w/w seasoning, with the remainder deionized water. The constituents of the premixture were combined in a baking tray and baked at 400° F. (205° C.) for 2 hours. After baking, the liquid was drained and filtered through several layers of cheesecloth while still hot. The resulting filtrate should be clear and devoid of any particulate matter. The filtrate may be filtered again to obtain clarity. Once prepared, part 1 of the greasy soil may be divided into smaller batches and refrigerated for up to 1 year in glass jars.

### Part 2: 100% Cacao, Unsweetened Chocolate Bar.

Finished Soil: 85-95% of Soil part 1; 5-15% of Soil part 2.

Set up water bath at 45° C. (113° F.). Place jar of part 1 soil in water bath to melt. Once melted, pour desired quantity of soil into a smaller beaker and place into water batch. Decrease temperature of water bath to 100° F. (38° C.). Add desired quantity of chocolate. Allow chocolate to melt in part 1 soil with stir bar and mix/stir. Keep beaker in water bath stirring to maintain temperature and homogeneity.

### Tile Preparation and Soiling:

Pre heat oven to 165° C. (329° F.). A number of identically sized rectangular white porcelain enameled steel tiles were cleaned with a mild detergent. The tiles were then rinsed with ethanol and allowed to air dry. Prior to soil application, the surface reflectance value “R1” for each cleaned tile was evaluated using a digital imager (such as an Ortery™ Photosimile 200 PhotoBooth device or similar). The R1 value for each tile was recorded.

### Cleaning Testing:

The finished soil prepared above is preheated to 38° C. (100° F.) using a water bath. A 1.7 g aliquot of the heated soil was applied to and evenly spread upon one surface of the tile laid on a horizontal laboratory bench resulting in a final soil weight between 1.0-1.10 g on each tile. The tiles were placed on trays and baked in a convection oven for 90 minutes at 329° F. (165° C.) to form the burnt-on greasy soil. Afterwards, the tiles were allowed to cool to room temperature (approx. 20° C.-22° C., approx. 68° F.-72° F.) for 24 hours. The test tiles were then used in evaluating the cleaning performance of a formula composition. Prior to the application of any cleaning composition onto a tile for cleaning performance evaluation, the surface reflectance of each soiled tile “R2” was evaluated using the digital imager. The R2 value for each tile was recorded.

The soil removal efficacy of a composition at room temperature was performed with the use of a Gardner Abrasion Tester. Individual cellulose sponges were washed in a washing machine and subject to three rinse cycles. Prior to testing, the sponges were wetted in water and manually squeezed to remove excess water.

A measured amount, between 15-25 g of a test formula composition was applied to one surface of the damp sponge. Immediately thereafter, the tile was placed in a Gardner Abrasion Tester, which was operated to provide a specific amount of cycles (each cycle being one forward and one return stroke) of cleaning. Once the cleaning cycle was completed, the tile was removed from the tester and the portion of the tile abraded by the sponge was rinsed gently with cool tap water for up to 5 seconds. Thereafter, the tested tile was permitted to dry. The surface reflectance of the portion of the tile abraded by the sponge “R3” was evaluated using the digital imager. The R3 value for each tile was recorded. Each formula composition was tested using four (4) tiles, thus providing four (4) replicates for each composition being tested.

The percentage of the burnt-on greasy test soil removed from each tile was determined utilizing the following equation:

% soil removal=[(R1−R2)/(R3−R2)]×100

The results of the testing, and the identity of the tested compositions are illustrated on the following Tables. The % soil removal are also indicated. The indicated results are the numerical average of the % soil removal values for the four (4) tiles used in the test.

TABLE 12

| | Formulation | | |
|---|---|---|---|
| | C8 | E8 | Water |
| Cleaning Cycles | 18 | 18 | 18 |
| % soil removal | 5.26% | 78.51% | 8.02% |

Based on the results in Table 12, Formulation C8 containing sodium bicarbonate performed worse than both Formulation E8 and water. Formulations C8 and E8 are the same base formula, with C8 containing sodium bicarbonate and E8 containing sodium carbonate. The drop in pH of Formulation C8 compared to E8 is believed to cause the inferior soil removal of baked on grease.

TABLE 13

| | Formulation | | |
|---|---|---|---|
| | E8 | E9 | Water |
| Cleaning cycles | 11 | 11 | 11 |
| % soil removal | 31.13% | 5.93% | 7.34% |

As seen from Table 13, Formulation E9 containing a 4 EO surfactant was compared to Formulation E8 containing 6 EO surfactant. Formulations E8 and E9 are the same base formula except the differences in EO ethoxylated alcohols used (4 EO vs 6 EO). Formulation E9 performed inferior to both Formulation E8 and water in its ability to effectively remove baked on grease.

### Example 13: Carbonate vs Bicarbonate Test

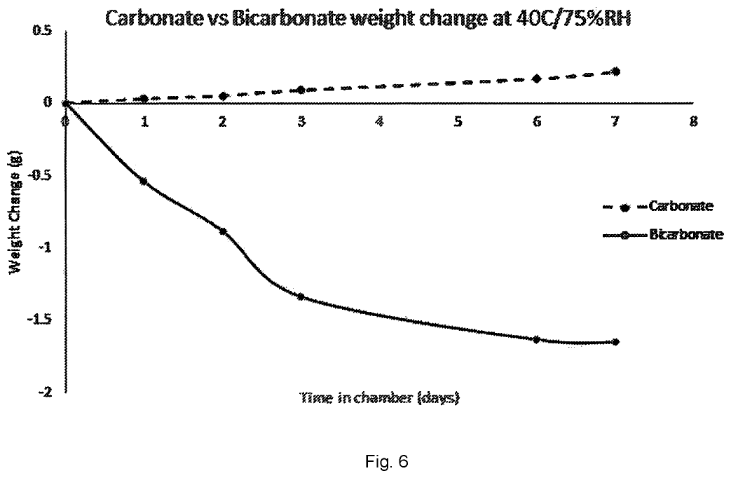

Samples were prepared in a glass jar by adding 5 g of Citric Acid DC, supplied by JBL, and 5 g of either Sodium Carbonate or Sodium Bicarbonate, supplied by Novacarb and Solvay respectively. The initial weights of each jar were measured. The jars were then capped with punctured parafilm and placed into the 40° C./75% relative humidity chamber. Each day the jars were removed from the chambers and their weights recorded. A graph of the weight of the jar versus time is provided in FIG. 6. The results of this study show that the carbonate-citric acid mixture gained weight while the bicarbonate-citric mixture lost over 1 g of weight. These results suggest that the moisture content threshold required to begin the autocatalytic reaction of the citric acid with the bicarbonate is much lower than that of the carbonate-citric acid mixture. These results suggest that the use of a carbonate anion in effervescent formulations provides stability benefits over using a bicarbonate anion by allowing more moisture to be absorbed in the final product before the autocatalytic reaction begins. Obviously, formulations containing less than 10% w/w carbonate or having more citric acid than bicarbonate may not exhibit a similar phenomenon.

### Example 14: Bactericidal Efficacy of Basic Formulations

Formulation E8 was tested to determine the minimum bactericidal activity in dirty conditions against Staphylococcus aureus (ATCC 6538), Pseudomonas aeruginosa (ATCC 15442), Escherichia coli (ATCC 10536), Enterococcus hirae (ATCC 10541).

Three (3) ten (10) gram tablets of Formulation E8 were added to 750 mL of hard water (Neat). 50% and 1% dilutions were prepared from the Neat solution.

8 mL aliquots of the formulation were tested following European Committee for Standardization EN 1276:2019 (Chemical Disinfectants and Antiseptics—Quantitative Suspension Test for the Evaluation of Bactericidal Activity of Chemical Disinfectants and Antiseptics Used in Food, Industrial, Domestic, and Institutional Areas). The log₁₀ reduction results are summarized in Table 14.

TABLE 14

| | Sample | | | |
|---|---|---|---|---|
| | S. aureus | P. aeru. | E. coli | E. hirae |
| | 5 minute | 5 minute | 5 minute | 5 minute |
| | exposure | exposure | exposure | exposure |
| | 20° C. ± 1° C. | 20° C. ± 1° C. | 20° C. ± 1° C. | 20° C. ± 1° C. |
| Neat | >5.17 log₁₀ | >5.24 log₁₀ | >5.09 log₁₀ | >5.09 log₁₀ |
| 50% | >5.17 log₁₀ | >5.24 log₁₀ | >5.09 log₁₀ | >5.09 log₁₀ |
| 1% | 4.18 log₁₀ | <1.87 log₁₀ | 3.17 log₁₀ | >5.06 |

As can be seen, the formulation exhibits bactericidal activity in suspension both neat and at 50% dilution. One of ordinary skill in the art will recognize that the germ kill is not impacted by the degree of ethoxylation on the alcohol ethoxylate and would expect similar results from formulation E9.

0.1 mL aliquots of the formulation was tested against P. aeruginosa following European Committee for Standardization EN 13697:2015+A1:2019 (Chemical Disinfectants and Antiseptics—Quantitative Non-porous Surfaces Test for the Evaluation of Bactericidal Activity and/or Fungicidal Activity of Chemical Disinfectants Used in Food, Industrial, Domestic, and Institutional Areas). The log₁₀ reduction results are summarized in Table 16.

TABLE 16

| | P. aeruginosa |
|---|---|
| | 10 minute exposure |
| Sample | 18-25° C. |
| Neat | 4.14 log₁₀ |
| 50% | 3.79 log₁₀ |
| 1% | <1.46 log₁₀ |

As can be seen, the Neat formulation exhibits surface bactericidal activity. One of ordinary skill in the art will recognize that the germ kill is not impacted by the degree of ethoxylation on the alcohol ethoxylate and would expect similar results from formulation E9.

### Example 15: Yeasticidal Efficacy of Basic Formulations

Formulation E8 was tested to determine the minimum yeasticidal activity in dirty conditions against Candida albicans (ATCC 10231).

Three (3) ten (10) gram tablets of Formulation E8 were added to 750 mL of hard water (Neat). 50% and 1% dilutions were prepared from the Neat solution.

8 mL aliquots of the formulations were tested against C. albicans following European Committee for Standardization EN 1650:2019 (Chemical Disinfectants and Antiseptics—Quantitative Suspension Test for the Evaluation of Fungicidal or Yeasticidal Activity of Chemical Disinfectants and Antiseptics Used in Food, Industrial, Domestic, and Institutional Areas)(Suspension).

0.1 mL aliquots of the formulations were tested against C. albicans following European Committee for Standardization EN 13697:2015+A1:2019 (Chemical Disinfectants and Antiseptics—Quantitative Non-porous Surfaces Test for the Evaluation of Bactericidal Activity and/or Fungicidal Activity of Chemical Disinfectants Used in Food, Industrial, Domestic, and Institutional Areas)(Surface).

The log 10 reduction results for both Suspension and Surface are summarized in Table 17.

TABLE 17

| | Suspension | Surface |
|---|---|---|
| | 15 minute exposure | 15 minute exposure |
| Sample | 20° C. ± 1° C. | 18-25° C. |
| Neat | >4.03 log₁₀ | >4.91 |
| 50% | 3.85 log₁₀ | >2.86 |
| 1% | 1.25 log₁₀ | 1.98 |

As can be seen, the Neat formulation exhibits yeasticidal activity both in suspension and surface testing conditions. One of ordinary skill in the art will recognize that the germ kill is not impacted by the degree of ethoxylation on the alcohol ethoxylate and would expect similar results from formulation E9.

### Example 16: Virucidal Efficacy of Basic Formulations

Formulation E8 was tested to determine the minimum virucidal activity against Influenza A virus (2009-H1N1)(Novel H1N1), Respiratory Syncytial Virus (RSV), SARS-Related Coronavirus 2 (SARS), and Vaccinia virus.

Three (3) ten (10) gram tablets of Formulation E8 were added to 750 mL of hard water (Neat). 50% and 1% dilutions were prepared from the solution. 1.6 mL aliquots of the formulations were tested against Novel H1N1 (CDC 2009712192), RSV (ATCC VR-26, Strain Long), SARS (BEI Resources NR-52281, Strain Isolate USA-WA1/2020), and Vaccinia (ATCC VR-119, Strain WR) following European Committee for Standardization BS EN 14476:2013+A2:2019 (Chemical Disinfectants and Antiseptics—Quantitative Suspension Test for the Evaluation of Virucidal Activity in the Medical Area). The log₁₀ reduction results are summarized in Table 18.

TABLE 18

| | Novel H1N1 | RSV | SARS | Vaccinia |
|---|---|---|---|---|
| | 10 minute exposure | 10 minute exposure | 10 minute exposure | 5 minute exposure |
| | 20° C. ± 1° C. | 20° C. ± 1° C. | 20° C. ± 1° C. | 20° C. ± 1° C. |
| Sample | Clean Conditions | Dirty Conditions | Dirty Conditions | Dirty Conditions |
| Neat | ≥4.5 log₁₀ | ≥4.0 log₁₀ | ≥4.33 log₁₀ | ≥4.67 log₁₀ |
| 50% | ≥5.5 log₁₀ | ≥4.0 log₁₀ | ≥5.33 log₁₀ | ≥4.67 log₁₀ |
| 1% | 0.67 log₁₀ | 0.17 log₁₀ | 0.33 log₁₀ | 0 |

As can be seen, the formulation exhibits virucidal activity in suspension both neat and at 50% dilution. One of ordinary skill in the art will recognize that the germ kill is not impacted by the degree of ethoxylation on the alcohol ethoxylate and would expect similar results from formulation E9.

Additional virucidal testing of Formulation E8 was performed in clean conditions at room temperature (18-25° C.) against Vaccinia virus. Neat, 50%, and 1% solutions were tested at ten (10), fifteen (15), and twenty (20) minute contact times. 100 μL aliquots of the formulations were tested against Vaccinia virus, strain Ankara (MVA, ATCC VR-1508) (BHK-21 host cell line, ATCC CCL-10) following European Committee for Standardization EN 16777:2018 (Quantitative Non-Porous Surface Test without Mechanical Action for the Evaluation of Virucidal Activity of Chemical Disinfectants Used in the Medical Area). The log₁₀ reduction results are summarized in Table 19.

TABLE 19

| Sample | 10 minutes | 15 minutes | 20 minutes |
|---|---|---|---|
| Neat | 3.0 log₁₀ | 3.0 log₁₀ | 3.0 log₁₀ |
| 50% | 4.0 log₁₀ | 4.0 log₁₀ | 4.0 log₁₀ |
| 1% | 0.66 log₁₀ | 0.66 log₁₀ | 0.66 log₁₀ |

As can be seen, the formulation exhibits surface virucidal activity both neat and at 50% dilution. One of ordinary skill in the art will recognize that the germ kill is not impacted by the degree of ethoxylation on the alcohol ethoxylate and would expect similar results from formulation E9.

### Example 17: Packaging Stability of Basic Formulations

Additional accelerated storage stability and corrosion studies were performed on tablets having Formula E8. Three (3) tablets were contained in one (1) flow wrap pack. Two different flow wrap materials were tested. Flow wrap A in Tables 20a-e below is a tri-layer flow wrap having an 8 micron thick Aluminum layer sandwiched between a 30 micron thick polyethylene layer and a 12 micron thick PET layer. The tablets were adjacent to the PE layer. Flow wrap B in Tables 20f-j below is an aluminum metallized oriented polypropylene film. The tablets were adjacent to the PP layer. The flow wrap containers were formed by three seams in overlapping portions of the laminate material, a left end seam which spans a width at one end, a right end seam that spans the width at the opposite end, and a side seam that spans a length between the end seams, forming a tubular package measuring approximately 110 mm to approximately 130 mm long by approximately 20 mm to approximately 30 mm wide. The tablets in the flow wrap packaging were stored at the conditions indicated in the tables below. As can be seen in Tables 20a-j below, the dissolution time for tablets stored in Flow wrap B is significantly higher at higher temperature and humidity conditions than the dissolution time for tablets stored in Flow Wrap A, demonstrating better barrier from atmospheric humidity. Applicants believe that the liquid alcohol ethoxylate may have permeated the polypropylene layer and slightly eroded the aluminum.

TABLE 20a
Flow Wrap A at 4.5° C., Uncontrolled Humidity

| | 0 Weeks | 2 Weeks | 4 Weeks | 6 Weeks | 12 Weeks |
|---|---|---|---|---|---|
| pH | 10.08 | 10.01 | 10.04 | 9.98 | 9.93 |
| Color | Pass | Pass | Pass | Pass | Pass |
| Appearance | Pass | Pass | Pass | Pass | Pass |
| Odor | 5 | 5 | 5 | 5 | 5 |
| % Quat | 0.176 | 0.189 | 0.186 | 0.174 | 0.176 |
| Dissolution | 10 | 14 | 12 | 15 | 11 |
| Time (min) | | | | | |

TABLE 20b
Flow Wrap A at 25° C., 50% Relative Humidity

| | 0 Weeks | 2 Weeks | 4 Weeks | 6 Weeks | 12 Weeks |
|---|---|---|---|---|---|
| pH | 10.08 | 10.05 | 10.02 | 10.01 | 9.94 |
| Color | Pass | Pass | Pass | Pass | Pass |
| Appearance | Pass | Pass | Pass | Pass | Pass |
| Odor | 5 | 5 | 5 | 5 | 5 |
| % Quat | 0.176 | 0.188 | 0.188 | 0.179 | 0.179 |
| Dissolution | 10 | 15 | 15 | 18 | 13 |
| Time (min) | | | | | |

TABLE 20c
Flow Wrap A at 40° C., 75% Relative Humidity

| | 0 Weeks | 2 Weeks | 4 Weeks | 6 Weeks | 12 Weeks |
|---|---|---|---|---|---|
| pH | 10.08 | 9.96 | 10.02 | 9.98 | 9.91 |
| Color | Pass | Pass | Pass | Pass | Pass |
| Appearance | Pass | Pass | Pass | Pass | Pass |
| Odor | 5 | 5 | 5 | 5 | 4.5 |
| % Quat | 0.176 | 0.184 | 0.187 | 0.179 | 0.180 |
| Dissolution | 10 | 15 | 17 | 20 | 24 |
| Time (min) | | | | | |

TABLE 20d
Flow Wrap A at 50° C., Uncontrolled Humidity

| | 0 Weeks | 1 Week | 2 Weeks | 4 Weeks | 6 Weeks |
|---|---|---|---|---|---|
| pH | 10.08 | 9.99 | 10.03 | 9.91 | 10.00 |
| Color | Pass | Pass | Pass | Pass | Pass |
| Appearance | Pass | Pass | Pass | Pass | Pass |
| Odor | 5 | 5 | 4.5 | 4.5 | 3.5 |
| % Quat | 0.176 | 0.181 | 0.184 | 0.187 | 0.177 |
| Dissolution | 10 | 15 | 16 | 34 | 65 |
| Time (min) | | | | | |

TABLE 20e
Flow Wrap A at 54° C., Uncontrolled Humidity

| | 0 Weeks | 1 Week | 2 Weeks |
|---|---|---|---|
| pH | 10.08 | 10.01 | 10.06 |
| Color | Pass | Pass | Pass |
| Appearance | Pass | Pass | Pass |
| Odor | 5 | 5 | 4.5 |
| % Quat | 0.176 | 0.176 | 0.183 |
| Dissolution | 10 | 18 | 29 |
| Time (min) | | | |

TABLE 20f
Flow Wrap B at 4.5° C., Uncontrolled Humidity

| | 0 Weeks | 2 Weeks | 4 Weeks | 6 Weeks | 12 Weeks |
|---|---|---|---|---|---|
| pH | 10.02 | 10.04 | 9.97 | 9.98 | 9.97 |
| Color | Pass | Pass | Pass | Pass | Pass |
| Appearance | Pass | Pass | Pass | Pass | Pass |
| Odor | 5 | 5 | 5 | 5 | 5 |
| % Quat | 0.175 | 0.170 | 0.180 | 0.178 | 0.177 |
| Dissolution | 10 | 17 | 12 | 16 | 19 |
| Time (min) | | | | | |

TABLE 20g
Flow Wrap B at 25° C., 50% Relative Humidity

| | 0 Weeks | 2 Weeks | 4 Weeks | 6 Weeks | 12 Weeks |
|---|---|---|---|---|---|
| pH | 10.02 | 9.99 | 10.04 | 9.96 | 10.01 |
| Color | Pass | Pass | Pass | Pass | Pass |
| Appearance | Pass | Pass | Pass | Pass | Pass |
| Odor | 5 | 5 | 5 | 5 | 5 |
| % Quat | 0.175 | 0.170 | 0.180 | 0.179 | 0.177 |
| Dissolution | 10 | 15 | 14 | 18 | 25 |
| Time (min) | | | | | |

TABLE 20h
Flow Wrap B at 40° C., 75% Relative Humidity

| | 0 Weeks | 2 Weeks | 4 Weeks | 6 Weeks | 12 Weeks |
|---|---|---|---|---|---|
| pH | 10.02 | 9.98 | 9.88 | 10.08 | 9.92 |
| Color | Pass | Fail | Fail | Fail | Fail |
| Appearance | Pass | Fail | Fail | Fail | Fail |
| Odor | 5 | 5 | 5 | 5 | 4 |
| % Quat | 0.175 | 0.169 | 0.180 | 0.177 | 0.175 |
| Dissolution | 10 | 33 | 50 | 65 | 56 |
| Time (min) | | | | | |

TABLE 20i
Flow Wrap B at 50° C., Uncontrolled Humidity

| | 0 Weeks | 1 Week | 2 Weeks | 4 Weeks | 6 Weeks |
|---|---|---|---|---|---|
| pH | 10.02 | 9.95 | 10.01 | 10.02 | 9.98 |
| Color | Pass | Fail | Fail | Fail | Fail |
| Appearance | Pass | Fail | Fail | Fail | Fail |
| Odor | 5 | 5 | 4.5 | 4.5 | 3.5 |
| % Quat | 0.175 | 0.175 | 0.174 | 0.178 | 0.178 |
| Dissolution | 10 | 15 | 17.5 | 41 | 68 |
| Time (min) | | | | | |

TABLE 20j
Flow Wrap B at 54° C., Uncontrolled Humidity

| | 0 Weeks | 1 Week | 2 Weeks |
|---|---|---|---|
| pH | 10.02 | 9.93 | 9.93 |
| Color | Pass | Fail | Fail |
| Appearance | Pass | Fail | Fail |
| Odor | 5 | 5 | 4.5 |
| % Quat | 0.175 | 0.182 | 0.177 |
| Dissolution | 10 | 21 | 29 |
| Time (min) | | | |

### Example 18: Alternative Basic Formulations

Additional testing was performed for an alternative basic formulation provided in Table 21 below. As shown in Example 12 and Table 13 above, formulation E9 exhibited inferior polymerized grease soil removal than formulation E8. The shorter chain length ethoxylates are unable to solubilize the grease but are very good at penetrating the polymerized layer. A combination of a larger chain ethoxylate with a smaller chain ethoxylate allows the formulation to penetrate the polymerized layer and carry away the soil.

TABLE 21

| Raw Material | E10 |
|---|---|
| BKC | 11.72 (4.69) |
| CA | 15.38 |
| KCarb | 49.22 |
| EO5 | 5.38 |
| EO8 | 5.38 |
| MGDA | 9.01 (7.2) |
| F | 3.88 |
| D | 0.023 |
| Dissolution time (in minutes) | ~5 |
| Foam overflow? | No |
| pH | ~9.8 |
| S. aureus, P. aeruginosa in dirty | 0/30 CFU |
| conditions with 5 minute contact time | |

The foregoing description of various aspects of the invention has been presented for purposes of illustration and description. Embodiments and/or features therein may be freely combined with one another. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A disinfectant composition comprising:
a. approximately 50 to approximately 75% w/w of citric acid encapsulated by a binder; and
b. approximately 1% to approximately 5.5% w/w of sodium benzoate.

2. The disinfectant composition of claim 1, further comprising approximately 10% w/w to approximately 15% w/w of sodium lauryl sulfate.

3. The disinfectant composition of claim 1, further comprising an effervescent.

4. The disinfectant composition of claim 1, further comprising a chelant.

5. The disinfectant composition of claim 1, further comprising a powdered or spray dried fragrance.

6. The disinfectant composition of claim 1, further comprising a binding agent.

7. The disinfectant composition of claim 6, wherein the binding agent is a liquid alkoxylated alcohol.

8. The disinfectant composition of claim 1, wherein the combined liquid content of all of the ingredients is less than 10% w/w of the formulation.

9. A disinfectant kit comprising:
a. the disinfectant composition of claim 1; and
b. a bottle having a fill line at a volume sufficient to obtain a disinfectant solution from the disinfectant composition and water, the disinfectant solution comprising approximately 1.2% w/v to approximately 2% w/v citric acid and approximately 0.083% w/v to approximately 0.15% w/v sodium benzoate.

10. The disinfect kit of claim 9, the bottle further comprising a spray trigger.

11. The disinfectant kit of claim 9, wherein the disinfectant composition is a tablet.

12. The disinfectant kit of claim 9, wherein the disinfectant composition is provided in a three-layer laminate material comprising an aluminum layer located between a polyethylene (PE) layer and a polyethylene terephthalate (PET) layer.

13. The disinfectant kit of claim 12, wherein three-layer laminate material forms a tubular pillow pouch to hold the disinfectant composition, the tubular pillow pouch formed by three seams in overlapping portions of the three-layer laminate material: a top seam which spans a width at one end, a bottom seam that spans the width at the opposite end, and a side seam that spans a length between the end seams.

14. The disinfectant kit of claim 9, wherein the bottle comprises a neck connected to a body via a concave shoulder, with a bottom of the concave shoulder being higher on one side of the bottle than on the other, wherein the shoulder occupies between approximately 5% to approximately 15% by volume of the bottle.

15. The disinfectant kit of claim 14, wherein the fill line is located at the bottom of the higher concave shoulder.

16. The disinfectant kit of claim 14, wherein the shoulder is patterned by (a) horizontally oriented concentric rings that run parallel to the slope between the lower and higher shoulders; (b) vertically oriented lines that run parallel to the concave shoulder; and (c) indentations formed between the concentric rings and vertically oriented lines.

17. The disinfectant kit of claim 16, wherein the pattern comprises between four and eight horizontally oriented concentric rings descending vertically from the neck of the bottle.

18. The disinfectant kit of claim 16, wherein the pattern comprises between five and twelve vertically oriented lines spaced around the perimeter of the bottle.

19. The disinfectant kit of claim 16, wherein the indentations form a rectangular flag shape pattern.

20. A method of providing a 5 log₁₀ reduction in Staphylococcus aureus on a surface in 5 minutes, the method comprising obtaining the disinfectant kit of claim 9, adding water to the fill line of the bottle, adding the composition to the bottle to produce a disinfectant solution, placing the spray trigger on the bottle, spraying the disinfectant solution on the surface, and wiping the surface after 10 minutes, producing a 5 log₁₀ reduction in Staphylococcus aureus on the surface.
